(19) United States
(12) Patent Application Publication
(10) Pub. No.: US 2008/0257681 A1
(43) Pub. Date: Oct. 23, 2008

(54) Coin Identifying Device

(75) Inventor: Nobuo Kurokawa, Tochigi (JP)

Correspondence Address: SMITH PATENT OFFICE, 1901 PENNSYLVANIA AVENUE N W, SUITE 901, WASHINGTON, DC, 20006, US

(73) Assignee: Bandai Co., Ltd., Taito-ku, Tokyo (JP)

(21) Appl. No.: 10/572,659

(22) PCT Filed: Dec. 21, 2004
(86) PCT No.: PCT/JP04/19669

§ 371 Date: Apr. 13, 2006

(30) Foreign Application Priority Data
Sep. 30, 2004 (JP) 2004/014786

(51) Int. Cl. G07F 5/04

(52) U.S. Cl. 194/334

(57) ABSTRACT

The coin identifying device is provided where the number of coins stored can be changed and a coin can be returned without a return button, and thus it is simple and inexpensive to make. The device has a coin slot, a coin outlet, and a rotating body. The rotating body has a coin containing section which can store multiple coins inserted from the coin slot, a switching member which changes the number of stored coins in the coin containing section, and a coin passage which is connected with the coin containing section and in which the coin falls to the coin outlet. A partition member inside a body of the device divides the coin containing section and the coin passage and does or does not prevent the coin in the coin containing section from falling to the coin passage depending on the direction of the rotation of the rotating body.

### TECHNICAL FIELD

The present invention relates to the coin identifying device where a rotating body becomes rotatable and a handle can be operated when a real coin is inserted from a slot, and where the rotating body is prevented from being rotated and the handle cannot be operated when a fake coin is inserted or no coin is inserted.

### BACKGROUND ART

A conventional coin identifying device is used while incorporated in an article dispensing machine, such as a capsule machine, where a rotating body inside a main body rotates when a coin is inserted and a handle is rotated, and where a rotating board of the article dispensing machine that rotates in accordance with the rotating body moves an article such as a capsule to an outlet.

A conventional coin identifying device, such as the one disclosed in Japanese Utility Model Publication No. 6-30872, for example, has a coin slot formed in the upper part, a coin outlet formed in the lower part, and a rotating body inside that can be operated by a handle. A coin containing section that can store coins inserted from the coin slot is formed in the rotating body. A locking member is provided in the body of a device. The locking member is pressed toward the stopping direction by an elastic member. When a real coin is not stored in the coin containing section or when a fake coin that has a smaller diameter than a real coin is stored in the coin containing section, the locking member stops a stopping edge of the rotating body at the time of rotation of the rotating body and prevents the rotation of the rotating body. When a real coin is stored in the coin containing section, the locking member is moved to the opposite of the stopping direction by a contact with an outer edge of the real coin at the time of rotation of the rotating body. Also, the rotation of the rotating body becomes possible without stopping the stopping edge of the rotating body, and the coin in the coin containing section can be discharged from the coin outlet. The conventional coin identifying device can also make coins stored in the coin containing section return by pushing a return button.

The conventional coin identifying device was not able to change the number of coins it could store. The amount of money inserted in an article dispensing machine, such as a capsule machine, in which the device is incorporated, could not be changed. Thus, the price of the article contained in the article dispensing machine had to stay the same. Also, since the conventional coin identifying device provided a return button to return a coin, the number of parts increased, its structure was complicated, and it could not be manufactured inexpensively.

In view of the above-mentioned problems, a first object of the present invention is to provide a coin identifying device that can change the number of coins it can store. A second object of the present invention is to provide a coin identifying device that can return a coin without using a return button, thereby simplifying its structure and making it inexpensive to manufacture.

### DISCLOSURE OF INVENTION

In order to achieve the first object described above, a coin identifying device defined by claim 1 of this application has the following structure. A body has a coin slot in an upper part, a coin outlet in a lower part, and a rotating body which is operated by a handle and which is rotatably provided inside the body; the rotating body has a coin containing section which can store a plurality of coins in a stack which are inserted from the coin slot; the body has a plurality of locking members corresponding to the correct number of coins, the plurality of locking members are pressed in a stopping direction by a respective elastic member, and can stop a stopping edge of the rotating body at the time of rotation of the rotating body and prevent rotation of the rotating body, when the correct number of coins are not stored or a false coin with a smaller diameter than a regular coin is stored in the coin containing section; and the plurality of locking members move opposite to the stopping direction by contacting with a periphery of each regular coin at the time of rotation of the rotating body to enable rotation of the rotating body without the stopping edge stopping the rotating body so that the plurality of coins in the coin containing section are discharged from the coin outlet, when the correct number of the regular coins are stored in the coin containing section; wherein the rotating body has a switching member rotatably provided which changes the number of coins stored in the coin containing section; the coin containing section comprises a first coin containing section formed in the rotating body and a second coin containing section formed in the switching member; and if the switching member is rotated in one direction against the rotating body, the second coin containing section overlaps with the first coin containing section of the rotating body so that the coin containing section comprises the second coin containing section and the first coin containing section, and if the switching member is rotated in the other direction against the rotating body, the second coin containing section separates from the first coin containing section of the rotating body so that the coin containing section only comprises the first coin containing section.

In order to achieve the first object described above, a coin identifying device defined by claim 2 of this application has the following structure. The switching member has a guide edge which moves the locking member opposite to the stopping direction by contacting with the locking member at the time of rotation of the rotating body so as not to stop the stopping edge of the rotating body, when the second coin containing section separates from the first coin containing section of the rotating body so that the coin containing section only comprises the first coin containing section.

In order to achieve the first object described above, a coin identifying device defined by claim 3 of this application has the following structure. The coin containing section of the rotating body has an engaging clutch piece pressed toward the engaging direction; and the engaging clutch piece engages with one side of the body at the time of rotation of the rotating body and prevents rotation of the rotating body when the correct number of coins are not stored or a false coin with different thickness than the regular coin is stored in the coin containing section, and moves opposite to the engaging direction and does not prevent rotation of the rotating body without engaging with the one side of the body at the time of rotation of the rotating body when the correct number of the regular coins are stored in the coin containing section.

In order to achieve the first object described above, a coin identifying device defined by claim 4 of this application has the following structure. Either one of the rotating body or the switching member has an engaging clutch convex portion or an engaging recess, and the other one of the rotating body or the switching member has first and second engaging recesses or first and second engaging clutch convex portions; and the switching member is positioned by the engaging clutch convex portion or the engaging recess engaging with the first engaging recess or the first engaging clutch convex portion, when the switching member is rotated in one direction against the rotating body, and the second coin containing section overlaps with the first coin containing section of the rotating body so that the coin containing section comprises the second coin containing section and the first coin containing section, and the switching member is positioned by the engaging clutch convex portion or the engaging recess engaging with the second engaging recess or the second engaging clutch convex portion, when the switching member is rotated in the other direction against the rotating body and the second coin containing section separates from the first coin containing section of the rotating body so that the coin containing section only comprises the first coin containing section.

In order to achieve the first object described above, a coin identifying device defined by claim 5 of this application has the following structure. The body has a coin slot in an upper part, a coin outlet in a lower part, and a rotating body which is operated by a handle and which is rotatably provided inside the body; the rotating body has a coin containing section which can store a plurality of coins in a stack which are inserted from the coin slot; the body has a plurality of locking members corresponding to the correct number of coins, the plurality of locking members are pressed toward a stopping direction by a respective elastic member, and can stop a stopping edge of the rotating body at the time of rotation of the rotating body and prevent rotation of the rotating body, when the correct number of coins are not stored or a false coin with a smaller diameter than a regular coin is stored in the coin containing section; and the plurality of locking members move opposite to the stopping direction by contacting with a periphery of each regular coin at the time of rotation of the rotating body to enable rotation of the rotating body without stopping the stopping edge of the rotating body so that the plurality of coins in the coin containing section are discharged from the coin outlet; wherein the coin containing section of the rotating body has a mounting part which attaches a changing member which changes the number of coins stored; and the changing member is attached to one side of the body and is detachably provided.

In order to achieve the second object described above, a coin identifying device defined by claim 6 of this application has the following structure. A body has a coin slot in an upper part, a coin outlet and a coin-return opening in a lower part, and a rotating body which is operated by a handle and which is rotatably provided inside the body; the rotating body has a coin containing section and stands by at an initial position where coins inserted from the coin slot are stored in the coin containing section; the body has a first locking member which is pressed toward a stopping direction; the first locking member stops a first stopping edge of the rotating body at the time of rotation of the rotating body in one direction from the initial position and prevents rotation of the rotating body, when no coin or a false coin with a smaller diameter than a regular coin is stored in the coin containing section; and the first locking member moves opposite to the stopping direction by contacting with a periphery of a regular coin at the time of rotation of the rotating body from the initial position in one direction, enables rotation of the rotating body in one direction without stopping the first stopping edge of the rotating body, and discharges the coin in the coin containing section from the coin outlet, when a regular coin is stored in the coin containing section; wherein the rotating body has a coin passage which is connected with the coin containing section and in which a coin falls to the coin-return opening; the body has a partition member which partitions the coin containing section and the coin passage; and the partition member partitions the coin containing section and the coin passage and prevents the coin in the coin containing section from falling to the coin passage at the time of rotation of the rotating body from the initial position in one direction, and does not partition the coin containing section and the coin passage so that the coin in the coin containing section falls to the coin passage and is returned to the coin-return opening at the time of rotation of the rotating body from the initial position in the other direction.

In order to achieve the second object described above, a coin identifying device defined by claim 7 of this application has the following structure. A body has a coin slot in an upper part, a coin outlet and a coin-return opening in a lower part, and a rotating body which is operated by a handle and which is rotatably provided inside the body; the rotating body has a coin containing section and stands by at a position where coins inserted from the coin slot are stored in the coin containing section; the body has a first locking member which is pressed toward a stopping direction by a first elastic member; the first locking member stops a first stopping edge of the rotating body at the time of rotation of the rotating body from the initial position in one direction and prevents rotation of the rotating body, when no coin or a false coin with a smaller diameter than a regular coin is stored in the coin containing section; and the first locking member moves opposite to the stopping direction by contacting with a periphery of a regular coin at the time of rotation of the rotating body from the initial position in one direction to enable rotation of the rotating body in one direction without stopping the first stopping edge of the rotating body so that the coin in the coin containing section is discharged from the coin outlet, when a regular coin is stored in the coin containing section; wherein the rotating body has a coin passage which is connected with the coin containing section and in which a coin falls to the coin-return opening, and further has a partition member which partitions the coin containing section and the coin passage; the partition member can move to a partition position to prevent a coin from falling and a non-partition position which allows a coin to fall, and is pressed toward the partition position by a fourth elastic member; and the body has an engaging member which does not engage with the partition member at the partition position and prevents the coin in the coin containing section from falling to the coin passage at the time of rotation of the rotating body from the initial position in one direction, and which engages with the partition member at the partition position and moves the partition member to the non-partition position against the elasticity of the fourth elastic member so that the coin in the coin containing section falls to the coin passage and is returned from the coin-return opening at the time of rotation of the rotating body from the initial position in the other direction.

In order to achieve the second object described above, a coin identifying device defined by claim 8 of this application has the following structure a body has a coin slot in an upper part, a coin outlet and a coin-return opening in a lower part, and a rotating body which is operated by a handle and which is rotatably provided inside the body; the rotating body has a coin containing section and stands by at a position where coins inserted from the coin slot are stored in the coin containing section; the body has a first locking member which is pressed toward a stopping direction by a first elastic member; the first locking member stops a first stopping edge of the rotating body at the time of rotation of the rotating body from the initial position in one direction and prevents rotation of the rotating body, when no coin or a false coin with a smaller diameter than a regular coin is stored in the coin containing section; and the first locking member moves opposite to the stopping direction by contacting with a periphery of a regular coin at the time of rotation of the rotating body from the initial position in one direction to enable rotation of the rotating body in one direction without stopping the first stopping edge of the rotating body so that the coin in the coin containing section is discharged from the coin outlet, when a regular coin is stored in the coin containing section; wherein the rotating body has a coin passage which is connected with the coin containing section and in which a coin falls to the coin-return opening, and further has a pair of coin stoppers between the coin containing section and the coin passage; the pair of coin stoppers can move to a closed position to prevent a coin from falling and an open position which allows a coin to fall, and is pressed toward the closed position by a fourth elastic member; and the body has an engaging member which does not engage with the pair of coin stoppers in the closed state and prevents the coin in the coin containing section from falling to the coin passage at the time of rotation of the rotating body from the initial position in one direction, and which engages with the pair of coin stoppers in the closed state and moves the pair of coin stoppers to the open position against the elasticity of the fourth elastic member so that the coin in the coin containing section falls to the coin passage and is returned from the coin-return opening at the time of rotation of the rotating body from the initial position in the other direction.

In order to achieve the second object described above, a coin identifying device defined by claim 9 of this application has the following structure. The body has a second locking member which is pressed toward a stopping direction by a second elastic member; and the second locking member stops a second stopping edge of the rotating body and prevents rotation of the rotating body in the other direction, after the rotating body is rotated from the initial position in the other direction and the coin in the coin containing section falls to the coin passage.

In order to achieve the second object described above, a coin identifying device defined by claim 10 of this application has the following structure. The body has a positioning device which positions the rotating body at the initial position; and the positioning device comprises an engaging member which engages with an engaged part formed in the rotating body or in an axis of rotation provided substantially at the center of the rotating body, and a third elastic member which presses the engaging member toward the engaging direction.

In order to achieve the second object described above, a coin identifying device defined by claim 11 of this application comprises: a body in which a coin slot is formed in an upper part, and a coin outlet and a coin-return opening are formed in a lower part; a rotating body rotatably provided inside the body; a partition member which is provided in the body and which projects into the rotating body; an opening provided at a periphery of the rotating body; a coin containing section which is provided in the rotating body, one end of which is connected to the opening, and the other end of which can take either a position facing or not facing the partition member according to rotation of the rotating body; and a coin passage which is formed in the rotating body to be at an obtuse angle to the coin containing section, one end of which is connected to the other end of the coin containing section and the other end of which is connected to the exterior of the rotating body; wherein when the rotating body is at the initial position where the coin slot and the opening of the body meet and when the rotating body is rotated from the initial position in one direction, a coin inserted from the coin slot is prevented from moving to the coin passage and is held in the coin containing section, because the partition member faces the other end of the coin containing section; when the rotating body is rotated 90 degrees or more from the initial position in one direction, the coin held in the coin containing section is discharged from the coin outlet via the opening due to the weight of the coin; and when the rotating body is rotated from the initial position in the other direction, the coin held in the coin containing section is enabled to move to the coin passage, and is discharged from the coin-return opening via the coin passage due to the weight of the coin, because the other end of the coin containing section does not face the partition member.

In order to achieve the second object described above, a coin identifying device defined by claim 12 of this application comprises: a body in which a coin slot is formed in an upper part, and a coin outlet and a coin-return opening are formed in a lower part; a rotating body rotatably provided inside the body; an opening provided at a periphery of the rotating body; a coin containing section which is provided in the rotating body, and one end of which is connected to the opening; a coin passage which is provided in the rotating body, one end of which is connected to the other end of the coin containing section, and the other end of which is connected to the exterior of the rotating body; a partition member which is provided in the rotating body, which partitions the coin containing section and the coin passage, which can move to a partition position to prevent a coin from falling and a non-partition position so as to allow a coin to fall, and which is pressed toward the partition position by a fourth elastic member; and an engaging member which is provided in the body, which does not engage with the partition member at the partition position and prevents the coin in the coin containing section from falling to the coin passage at the time of rotation of the rotating body from the initial position in one direction, and which engages with the partition member at the partition position and moves the partition member to the non-partition position against the elasticity of the fourth elastic member so that the coin in the coin containing section falls to the coin passage and is returned from the coin-return opening at the time of rotation of the rotating body from the initial position in the other direction; wherein when the rotating body is at the initial position where the coin slot and the opening of the body meet and when the rotating body is rotated from the initial position in one direction, a coin inserted from the coin slot is prevented from moving to the coin passage and is held in the coin containing section, because the partition member does not engage with the engaging member and is at the partition position; when the rotating body is rotated 90 degrees or more from the initial position in one direction, the coin held in the coin containing section is discharged from the coin outlet via the opening due to the weight of the coin; and when the rotating body is rotated from the initial position in the other direction, the coin held in the coin containing section moves to the coin passage, and is discharged from the coin-return opening via the coin passage due to the weight of the coin, because the partition member engages with the engaging member and moves to the non-partition position.

In order to achieve the second object described above, a coin identifying device defined by claim 13 of this application comprises: a body in which a coin slot is formed in an upper part, and a coin outlet and a coin-return opening are formed in a lower part; a rotating body rotatably provided inside the body; an opening provided at a periphery of the rotating body; a coin containing section which is provided in the rotating body, and one end of which is connected to the opening; a coin passage which is provided in the rotating body, one end of which is connected to the other end of the coin containing section, and the other end of which is connected to the exterior of the rotating body; a pair of coin stoppers which are provided in the body, which close an opening between the coin containing section and the coin passage, which can move to a closed position to prevent a coin from falling and an open position so as to allow a coin to fall, and which are pressed toward the closed position by a fourth elastic member; and an engaging member which is provided in the body, which does not engage with the pair of coin stoppers in the closed state and prevents the coin in the coin containing section from falling to the coin passage at the time of rotation of the rotating body from the initial position in one direction, and which engages with the pair of coin stoppers in the closed state and moves the pair of coin stoppers to the open position against the elasticity of the fourth elastic member so that the coin in the coin containing section falls to the coin passage and is returned from the coin-return opening at the time of rotation of the rotating body from the initial position in the other direction; wherein when the rotating body is at the initial position where the coin slot and the opening of the body meet and when the rotating body is rotated from the initial position in one direction, a coin inserted from the coin slot is prevented from moving to the coin passage and is held in the coin containing section, because the pair of coin stoppers do not engage with the engaging member and are at the closed position; when the rotating body is rotated 90 degrees or more from the initial position in one direction, the coin held in the coin containing section is discharged from the coin outlet via the opening due to the weight of the coin; and when the rotating body is rotated from the initial position in the other direction, the coin held in the coin containing section moves to the coin passage, and is discharged from the coin-return opening via the coin passage due to the weight of the coin, because the pair of coin stoppers engage with the engaging member and move to the open position.

### BRIEF DESCRIPTION OF DRAWINGS

FIG. 1 is a perspective view of a coin identifying device according to the present invention.

FIG. 2 is an exploded perspective view of the coin identifying device according to the present invention.

FIG. 3 is a perspective view of a case of the coin identifying device according to the present invention.

FIG. 4 is an exploded perspective view of a rotating body of the coin identifying device according to the present invention.

FIG. 5 is an assembly perspective view of the rotating body of the coin identifying device according to the present invention.

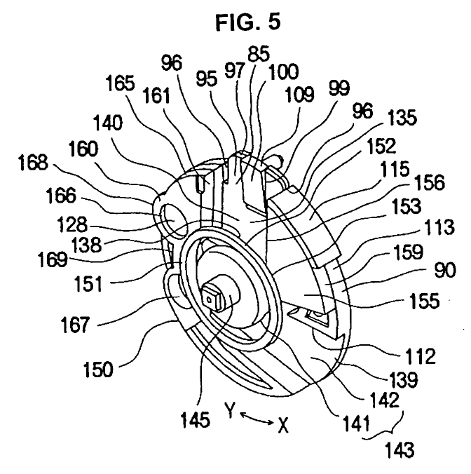

FIG. 6 is a perspective view explaining movement of the rotating body of the coin identifying device according to the present invention.

FIG. 7 is an exploded perspective view of a lid member of the coin identifying device according to the present invention.

FIG. 8 is an elevational view explaining movement of the coin identifying device with the lid member removed according to the present invention.

FIG. 9 is an elevational view showing a state where the counterclockwise rotation of the rotating body is prevented by the locking member.

FIG. 10 is an elevational view showing a state where a coin is unlocking the locking member.

FIG. 11 is an elevational view showing the state where the rotating body is rotated about 120 degrees counterclockwise.

FIG. 12 is an elevational view showing a state just before the rotating body drops a coin to an outlet.

FIG. 13 is an elevational view showing a state where the rotating body is rotated about 270 degrees counterclockwise.

FIG. 14 is an elevational view showing a state where the clockwise rotation of the rotating body is prevented by the locking member.

FIG. 15 is a perspective view of the coin identifying device from one side according to a second embodiment of the present invention.

FIG. 16 is a perspective view of the coin identifying device from the other side according to the second embodiment of the present invention.

FIG. 17 is an exploded perspective view of the coin identifying device according to the second embodiment of the present invention.

FIG. 18 is an exploded perspective view of the rotating body of the coin identifying device according to the second embodiment of the present invention.

FIG. 19 is an elevational view showing a state where the counterclockwise rotation of the rotating body is prevented by the locking member.

FIG. 20 is an elevational view showing a state where a coin is stored in a coin containing section of the rotating body.

FIG. 21 is an elevational view showing a state where a coin is unlocking the locking member.

FIG. 22 is an elevational view showing a state where the rotating body is rotated about 120 degrees counterclockwise.

FIG. 23 is an elevational view showing a state where the clockwise rotation of the rotating body is prevented by the locking member.

### BEST MODE FOR CARRYING OUT THE INVENTION

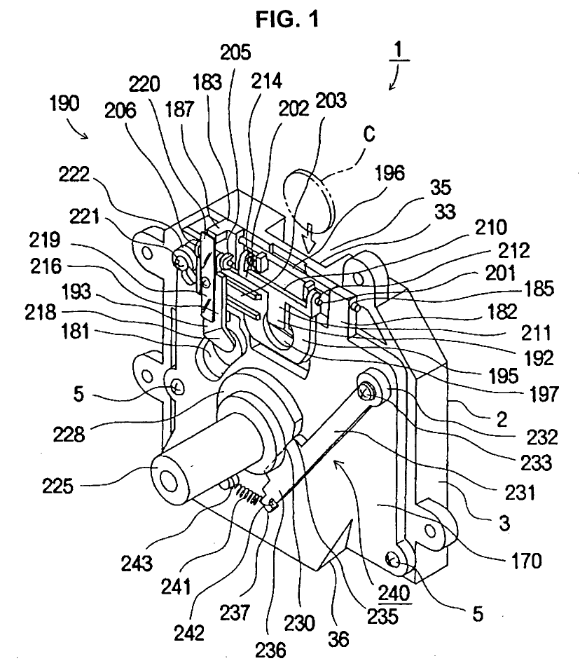

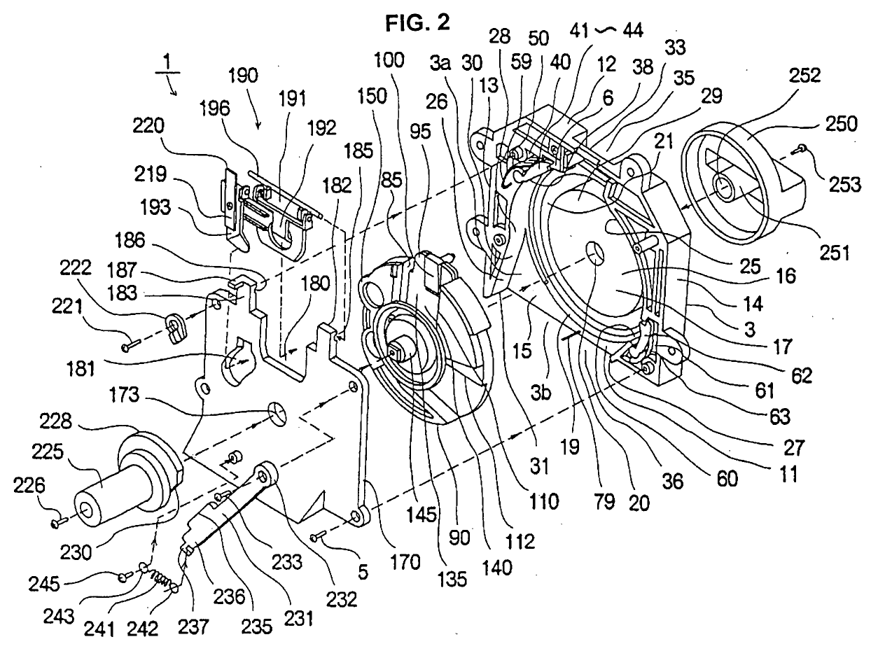

One embodiment of a coin identifying device is explained below. As shown in FIGS. 1 and 2, a body 2 of a coin identifying device 1 has a coin slot 35 in an upper part, a coin outlet 36 in a lower part, and a rotating body 90 inside which is operated by a handle 250. The rotating body 90 has an opening 85 which receives a coin C inserted from the coin slot 35, and a coin containing section 135 which connects with the opening 85 at one side and can store a plurality of coins in layers. The body 2 also has a plurality of locking members 41-44 corresponding to the number of coins C.

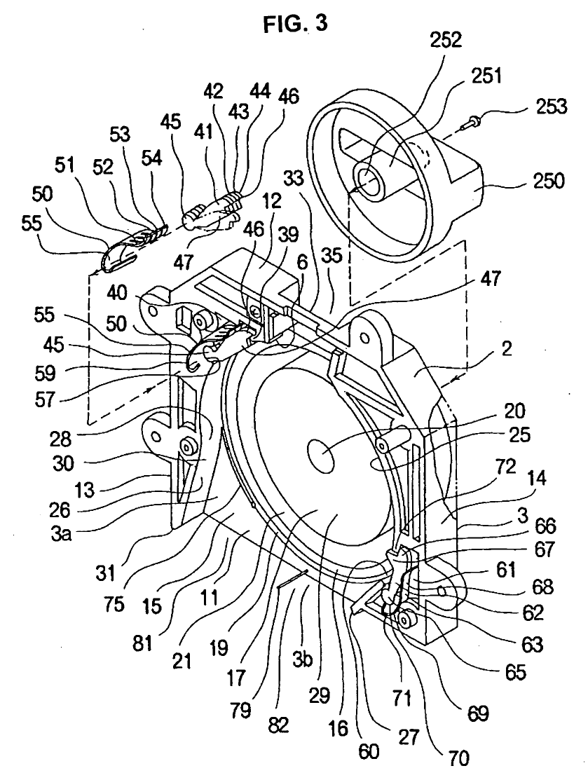

As shown in FIG. 3, the locking members are each pressed toward the stopping direction by an elastic member 50. When a correct number of real coins C are not stored in the coin containing section 135 or when a fake coin that has a smaller diameter than a real coin is stored in the coin containing section 135, the locking members 41-44 stop a stopping edge 116 of the rotating body 90 and prevent the rotation of the rotating body 90. Also, when a correct number of the real coins C are stored in the coin containing section 135, the locking members 41-44 are moved away from the stopping direction by a contact with a periphery of each real coin C. Also, the rotation of the rotating body 90 becomes possible without the stopping edge 116 stopping the rotating body 90 and the plurality of coins C in the coin containing section 135 can be discharged from the coin outlet 36.

A switching member 150 that changes the number of coins stored in the coin containing section 135 is rotatably provided in the rotating body 90. The coin containing section 135 comprises a first coin containing section 140 formed in the rotating body 90 and a second coin containing section 154 formed in the switching member 150. When the switching member 150 is rotated in one direction (X direction; counterclockwise) against the rotating body 90, the second coin containing section 154 overlaps with the first coin containing section 140 of the rotating body 90 to form the coin containing section 135. When the switching member 150 is rotated in the other direction (Y direction; clockwise) against the rotating body 90, the second coin containing section 154 comes off from the first coin containing section 140 of the rotating body 90, and only the first coin containing section 140 constitutes the coin containing section 135.

The switching member 150 has a guide edge 168. When the second coin containing section 154 comes off from the first coin containing section 140 of the rotating body 90 so that the coin containing section 135 only comprises the first coin containing section 140, the guide edge 168 moves the locking members 41-44 away from the locking direction at the time of rotation of the rotating body 90 and prevents the stopping edge 116 of the rotating body 90 from stopping the locking members 41-44.

An engaging clutch piece 100 pressed in the engaging direction is formed in the coin containing section 135 of the rotating body 90. When the correct number of real coins C are not stored in the coin containing section 135 or when a fake coin that has a different thickness from a real coin C is stored in the coin containing section 135, the engaging clutch piece 100 prevents rotation of the rotating body 90 by engaging with one side 6 of the body 2. When the correct number of the real coins C are stored in the coin containing section 135, the engaging clutch piece 100 moves away from the stopping direction, does not engage with the side 6 of the body 2, and it also does not prevent the rotation of the rotating body 90.

An engaging clutch convex portion 128 or an engaging recess is formed in either one of the rotating body 90 or the switching member 150. First and second engaging recesses 166 and 167, or first and second engaging clutch convex portions are formed in the other one of the rotating body 90 or the switching member 150. When the second coin containing section 154 overlaps with the first coin containing section 140 of the rotating body 90 to form the coin containing section 135 by rotating the switching member 150 in one direction (X direction; counterclockwise) against the rotating body 90, the switching member 150 is positioned so that the engaging clutch convex portion 128 or the engaging recess engages with the first engaging recess 166 or the first engaging clutch convex portion. When the second coin containing section 154 comes off from the first coin containing section 140 of the rotating body 90 and the coin containing section 135 only comprises the first coin containing section 140 by rotating the switching member 150 in the other direction (Y direction; clockwise) against the rotating body 90, the switching member 150 is positioned so that the engaging clutch convex portion 128 or the engaging recess engages with the second engaging recess 167 or the second engaging clutch convex portion.

A coin slot 35 is formed in the upper part, a coin outlet 36 is formed in the lower part, and a rotating body 90 that is operated by a handle 250 is provided inside of the body 2 of the coin identifying device 1. The rotating body 90 has the coin containing section 135, and is standing by at an initial position where the coin C inserted from the coin slot 35 is stored in the coin containing section 135. The first locking members 41-44 are pressed toward the stopping direction by a first elastic member 50. When the correct number of real coins C are not stored in the coin containing section 135 or when a fake coin that has a smaller diameter than a real coin is stored in the coin containing section 135, the locking members 41-44 stop the stopping edge 116 of the rotating body 90 and prevent the rotation of the rotating body 90 in one direction (X direction; counterclockwise). When the correct number of real coins C are stored in the coin containing section 135, the locking members 41-44 move away from the stopping direction by contact with a periphery of the real coins C. The rotation of the rotating body 90 in one direction (X direction; counterclockwise) becomes possible without the stopping edge 116 stopping the rotating body 90, and so the coins C in the coin containing section 135 can be discharged from the coin outlet 36.

The coin passage 143 which is connected with the containing section 135 and in which the coin C falls to the coin outlet 36 is formed in the rotating body 90. The partition member 175 that partitions the coin containing section 135 and the coin passage 143 is formed in the body 2. The partition member 175 prevents the coin C in the coin containing section 135 from falling to the coin passage 143 at the time of the rotation of the rotating body 90 from the initial position in one direction (X direction; counterclockwise). At the time of the rotation of the rotating body 90 from the initial position to the other direction (Y direction; clockwise), the partition member 175 does not prevent the coin C in the coin containing section 135 from falling into the coin passage 143, and the coin C is discharged from the coin outlet 36.

The second locking member 62 is pressed toward the stopping direction by the second elastic member 63 in the body 2. After the rotating body 90 is rotated from the initial position in the other direction (Y direction; clockwise) and the coin C in the coin containing section 135 falls to the coin passage 143, the second locking member 62 stops the second stopping edge 117 of the rotating body 90 and prevents further rotation of the rotating body 90 (Y direction; clockwise).

A positioning device 240 which positions the rotating body 90 at the initial position is formed in the body 2. The positioning device 240 comprises an engaging member 231 which engages with an engaged part 230 formed in the axis of rotation 225 provided on the rotating body 90 or substantially at the center of the rotating body 90 and a third elastic member 241 which presses the engaging member 231 in the engaging direction.

The coin identifying device 1 comprises: the body 2 which has the coin slot 35 in the upper part and the coin outlet 81 or the coin-return opening 82 in the lower part; the rotating body 90 which is rotatably provided inside the body 2; the partition member 175 which is provided in the body 2 and projects into the rotating body 90; the opening 85 provided at a periphery of the rotating body 90; the coin containing section 135 which is provided in the rotating body 90, one end 136 of which is connected with the opening 85, and the other end 137 of which can take the position where it does and does not face the partition member 175 according to rotation of the rotating body 90; and the coin passage 143 provided in the rotating body 90, one end 138 of which is connected with the other end 137 of the coin containing section 135, the other end 139 of which is connected with the periphery of the rotating body 90, and it is provided at an obtuse angle to the coin containing section 135.

The coin C inserted from the coin slot 35 is prevented from moving to the coin passage 143 and is stored in the coin containing section 135, because the partition member 175 faces the other end 137 of the coin containing section 135 when the rotating body 90 is at the initial position where the coin slot 35 and the opening 85 of the body 2 face each other or when the rotating body 90 is rotated from the initial position in one direction. The coin C stored in the coin containing section 135 is discharged due to its own weight from the coin outlet 81 via the opening 85 when the rotating body 90 is rotated 90 degrees or more from the initial position in one direction. The coin C stored in the coin containing section 135 moves to the coin passage 143 and is discharged due to its own weight from the coin-return opening 82 through the coin passage 143 when the rotating body 90 is rotated from the initial position in the other direction.

A more detailed explanation is as follows. As shown in FIG. 1, the coin identifying device 1 has the body 2 formed in the shape of a rectangular box. As shown in FIG. 2, the body 2 comprises the case 3 and a lid member 170 attached in the rear of the case 3 by a fixing device 5 such as a screw, and the rotating body 90 is formed inside to be rotatable in one direction (X direction; counterclockwise). As shown in FIG. 3, the case 3 has a front wall 11, a top wall 12 formed in the upper part of the front wall 11, a left wall 13 formed in the left-hand side of the front wall 11, and a right wall 14 formed in the right-hand side of the front wall 11, and the lower part and the rear part are open. A rear releasing part 3a of the case 3 is closed by the lid member 170, and the lower releasing part 3b of the case 3 forms the coin outlet 36. The heights of the top wall 12, the left wall 13, and the right wall 14 are substantially the same.

A circular concave portion 16 is formed in the interior 15 of the front wall 11. The base 17 and its side 19 are formed in the circular concave portion 16. The axis hole 20 is formed substantially in the center, and a concave gap 21 annular to the axis hole 20 is further formed in the bottom 17. Moreover, a semicircular first guide wall 25 and a straight second guide wall 26 are formed in the interior 15 of the front wall 11. The first guide wall 25 is formed along with the periphery of the circular concave portion 16 from a lower right end 27 located in the lower releasing part 3b, and is connected with the upper end 20 of the second guide wall 26 at the left end 28 located in the left side of the circular concave portion 16 if seen from the direction of the interior 15. (Hereafter each “right” and “left” in this embodiment means “right” and “left” as seen from the direction of the interior 15.) A lower end 31 of the second guide wall 26 is connected with a lower end of the left wall 13. A storage room 29 which stores the rotating body 90 is formed in the case 3 by the first guide wall 25 and the second guide wall 26.

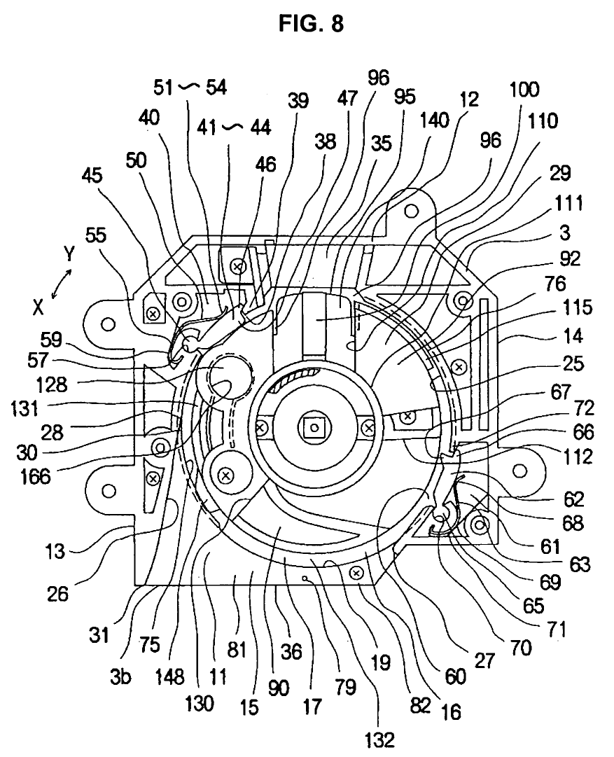

The coin slot 35 which is connected with the case 3 is formed by a notch 33 substantially in the shape of an angular letter U, substantially at the center of the top wall 12. As shown in FIG. 8, a notch section 38 is formed in the upper left portion of the first guide wall 25. Thus, an upper concave portion 40 surrounded by the top wall 12, the left wall 13, and the first guide wall 25 is formed around the top wall 12 of the case 3. The upper concave portion 40 is connected with the storage room 29 by the notch section 38. Moreover, the first elastic member 50 which presses four stop claw members (the first locking members) 41-44 are formed in the upper concave portion 40. The stop claw members (the first locking member) 41-44 are formed in a long flat shape, and have an axial part 45 in a lower end, an engaging clutch edge 46 in an upper end, and a stopping projection 47 in the storage room 29 at the upper end. The first elastic member 50 is formed with a metal plate, its lower part 55 is bent substantially in the shape of a letter U, and its upper part is separated into four parts, which form elastic pieces 51-54.

As shown in FIG. 8, an axis receiving part 57 substantially in the shape of a letter C and a plug slot 59 substantially in the shape of a letter U are formed at a lower side of the notch section 38 inside of the upper concave portion 40. The stop claw members (the first locking members) 41-44 are layered and attached so that the axis part 45 is movable in the axis receiving part 57. The first elastic member 50 is attached by inserting the lower part 55 substantially in the shape of a letter U into the plug slot 59. Four elastic pieces 51-54 contact the stop claw members 41-44 (the first locking members) respectively and press them toward the interior of the case 3. Of the stop claw members (the first locking members) 41-44 pressed by the first elastic member 50, the engaging clutch edge 46 contacts an engaging projection 39 formed in the upper part of the notch section 38, and the stopping projection 47 projects in the storage room 29 from the notch section 38.

A notch section 60 is formed around a lower right end 27 of the first guide wall 25. A lower concave portion 61 surrounded by the right wall 14 and the first guide wall 25 is formed near the lower releasing part 3b in the interior 15 of the front wall 11. The lower concave portion 61 is connected with the storage room 29 by the notch section 60. Moreover, a second elastic member 63 which presses a stop claw member (the second locking member) 62 is formed in the lower concave portion 61. The stop claw member (the second locking member) 62 is formed in a long flat shape, and has an axial part 65 in a lower end, an engaging clutch edge 66 in an upper end, and a stopping projection 67 in a lower side of the storage room 29 of the upper end. The second elastic member 63 is formed with a metal plate, and its lower part 69 is bent substantially in the shape of a letter U.

An axis receiving part 70 substantially in the shape of a letter C and a plug slot 71 substantially in the shape of a letter U are formed at a lower side of the notch section 60 inside of the lower concave portion 61. The stop claw member (the second locking member) 62 is attached so that the axis part 65 is movable in the axis receiving part 70. The second elastic member 63 is attached by inserting the lower part 69 into the plug slot 71. An upper part 68 contacts with the stop claw member (the second locking member) 62 and presses it toward the interior of the case 3. The stop claw member (the second locking member) 62 pressed by the second elastic member 63. The engaging clutch edge 66 contacts with an engaging projection 72 in the upper part of the notch section 60. The stopping projection 67 projects in the storage room 29 from the notch section 60.

A first guide groove 75 and a second guide groove 76 are formed in a side 19 of the circular concave portion 16. The first guide groove 75 extends from the lower end of the notch section 38 to near the lower releasing part 3b. The second guide groove 76 extends from the coin slot 35 to the upper end of the notch section 60. The lower releasing part 3b is divided into the first outlet (coin outlet) 81 and the second outlet (coin-return opening) 82 by a pin 79 which projects into the interior 15 of the front wall 11.

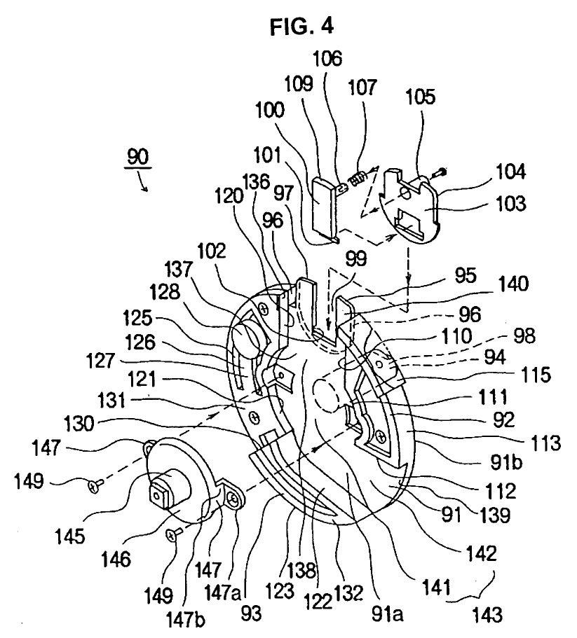

As shown in FIG. 4, the rotating body 90 has a disk-shaped substrate 91, a right guide member 92 and a left guide member 93 provided on the surface 91a (surface which does not contact with the interior 15 of the front wall 11) of the substrate 91, and an axis of rotation 94 provided substantially at the center of a back surface 91b of the substrate 91. The thickness of the substrate 91 is substantially the same as the depth of the side 19 which forms the concave portion 16 of the case 3. A protruding piece 95 projected from the substrate 91 to the outside is formed between the right guide member 92 and the left guide member 93. The protruding piece 95 has a groove 96, 96 at each of the left and right sides, and the upper end 97 projects from the periphery of the substrate 91. A notch 99 substantially in the shape of an angular letter U is formed in the protruding piece 95, and an engaging clutch piece 100 is provided in the notch 99.

An axis 101 is formed in the lower part of the engaging clutch piece 100, and both sides of the axis 101 are received at axis receiving concave portions 102 formed at both lower sides of the notch 99. A fixed board 103 which closes the notch 99 is fixed in the back 91b of the substrate 91. A guide cylinder 105 which projects from a back 104 of the fixed board 103 is formed in the fixed board 103. A guide shaft 106 which is inserted into the guide cylinder 105 is formed in the upper back surface of the engaging clutch piece 100. The engaging clutch piece 100 is pressed so that an upper edge 109 of the engaging clutch piece 100 protrudes inwardly from the surface 91a of the substrate 91 by a spring-shaped elastic member 107 looped around the guide shaft 106.

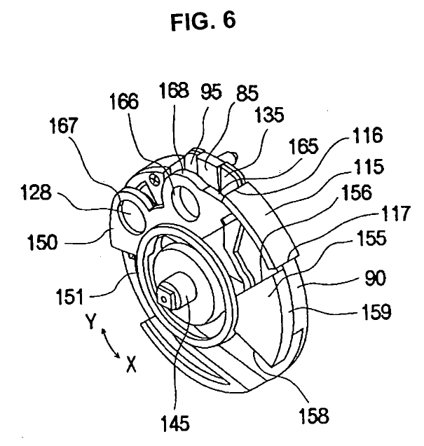

The right guide member 92 comprises an upper right guide surface 110 formed substantially in parallel to the right edge of the protruding piece 95, a right curved surface 111 which upper end is connected with the lower end of the upper right guide surface 110, a lower right guide surface 112 having a left end connected with the lower end of the right curved surface 111, and a right outer perimeter surface 113 that connects the right end of the lower right guide surface 112 and the upper end of the upper right guide surface 110. The right outer perimeter surface 113 shares substantially the same radius with the substrate 91. A stopper piece 115 which curves along with the periphery of the substrate 91 and protrudes outwardly from the periphery of the substrate 91 is formed substantially in the upper half of the right outer perimeter surface 113. As shown in FIG. 6, a first stopping edge 116 is formed in the upper end, and a second stopping edge 117 is formed in the lower end of the stopper piece 115.

The left guide member 93 comprises: an upper left guide surface 120 formed substantially in parallel with the left edge of the protruding piece 95; a left curved surface 121 having an upper end connected with the lower end of the upper left guide surface 120; a lower left guide surface 122 having a left end connected with the lower end of the left curved surface 121; and a left outer perimeter surface 123 which connects the right end of the lower left portion guide surface 122 and the upper end of the upper left guide surface 120. The left outer perimeter surface 123 has the same radius as the substrate 91. The left guide member 93 is divided into an upper part 131 and a lower part 132 by an engaging step portion 130. The upper part 131 of the left guide member 93 shares substantially the same height with the right guide member 92, which is substantially equivalent to the thickness of two coins. The lower part 132 of the left guide member 93 is higher than the upper part 131.

An engaging clutch piece 126 is formed at the upper part 131 of the left guide member 93 by a notch 125 substantially in the shape of an angular letter U. The engaging clutch piece 126 comprises a bendable piece 127 one end of which is connected with the substrate 91 and an engaging clutch convex portion 128 formed at the other end of the bendable piece 127. The engaging clutch convex portion 128 is formed in a disk shape and protrudes from the upper part 131 of the left guide member 93.

The first coin containing section 140 is formed by the upper right guide surface 110 of the right guide member 92 and the upper left guide surface 120 of the left guide member 93 in the rotating body 90. The distance between the upper right guide surface 110 of the right guide member 92 and the upper left guide surface 120 of the left guide member 93 is set to be slightly longer than the diameter of a coin C. Also, a first coin passage 141 is formed by the right curved surface 111 of the right guide member 92 and the left curved surface 121 of the left guide member 93 in the rotating body 90. Further, a second coin passage 142 is formed by the lower right guide surface 112 of the right guide member 92 and the lower left guide surface 122 of the left guide member 93 in the rotating body 90. A coin passage 143 substantially in the shape of a letter L which is connects to the first coin containing section 140 is formed by the first coin passage 141 and the second coin passage 142. An upper end (one end) of the first coin containing section 140 is connected with the opening 85 provided at the periphery of the rotating body 90, and a lower end (other end) 137 is connected with the upper end (one end) 138 of the first coin passage 141. The lower end (other end) 139 of the second coin passage 142 is connected with the exterior of the rotating body 90. This second coin passage 142 is formed so that it meets with the first coin containing section 140 at an obtuse angle.

As shown in FIG. 4, a mounting piece 147, 147 is formed near the right curved surface 111 and the left curved surface 121 of the surface 91a of the substrate 91. The mounting piece 147, 147 is formed substantially in the shape of a letter L and comprises a bottom wall 147a fixed to the substrate 91 by a fixing device 149, 149 such as a screw and a side wall 147b formed substantially at a right angle to the bottom wall 147a. The mounting pieces 147, 147 is fixed at the center of the substrate 91, and the diameter of the mounting piece 147, 147 is set to be a little larger than the diameter of the coin C. Thus, the first coin passage 141 does not prevent passage of the coin C. The side wall 147b, 147b is taller than the thickness of at least four coins. A disk-shaped mounting plate 146 is attached to the upper end of the side wall 147b, 147b of the mounting piece 147, 147. A center axis 145 which is substantially coaxial with the axis of rotation 94 is formed in the mounting plate 146. A guide piece 148, which moves along the first guide groove 75 formed in the side 19 of the concave portion 16 of the case 3, projects from the periphery of the rotating body 90.

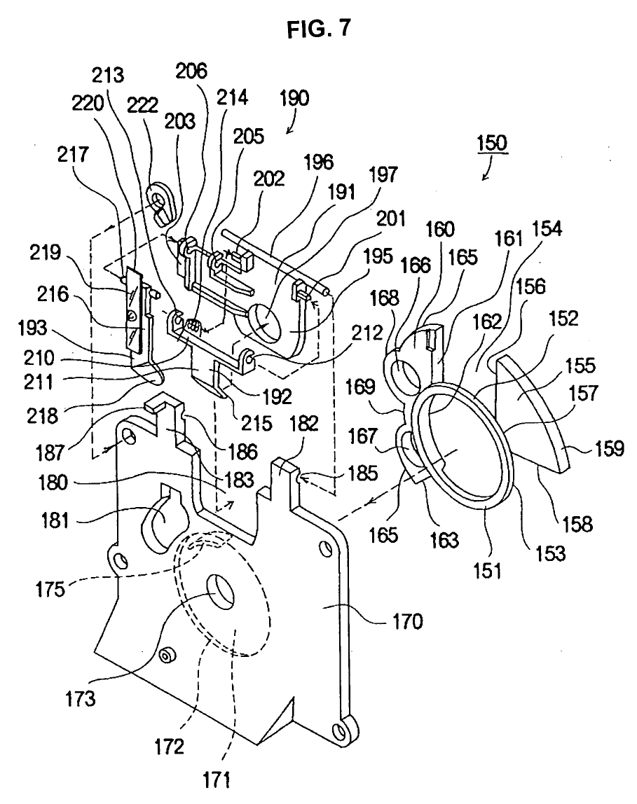

A switching member 150 is rotatably provided in the rotating body 90. As shown in FIG. 7, the switching member 150 has a guide ring 151, and a right guide member 155 in the shape of a fan projecting from the guide ring 151 is formed on the back 153 of the guide ring 151. The right guide member 155 comprises: an upper right guide surface 156 which is substantially parallel to the diameter of the guide ring 151; a right curved surface 157 having an upper end which is connected with the lower end (the end connected with the guide ring 151) of the upper right guide surface 156 and having substantially the same radius as the guide ring 151; a lower right guide surface 158 projecting from the lower end of the right curved surface 157 over the guide ring 151; and the right outer perimeter surface 159 which connects the right end (the end which is not connected with the guide ring 151) of the lower right guide surface 158 and the upper end (end which is not connected with the guide ring 151) of the upper right guide surface 156. The right outer perimeter surface 159 has substantially the same radius as the substrate 91. The thickness of the right guide member 155 is substantially the same as the thickness of two coins.

An upper left guide surface 161 protrudes substantially in parallel to the upper right guide surface 156, and the distance between the upper left guide surface 161 and the upper right guide surface 156 of the guide ring 151 is slightly larger than the diameter of the coin C. The upper left guide surface 161, a left curved surface 162, a lower left guide surface 163, and a left outer perimeter surface 165 constitute a left guide member 160. The upper end of the left curved surface 162 is connected with the lower end of the upper left guide surface 161 (the end connected with the guide ring 151), and the left curved surface 162 has substantially the same radius as the guide ring 151. The right end of the lower left guide surface 163 is connected with the lower end of the left curved surface 162, and the lower left guide surface 163 projects over the guide ring 151. The left outer perimeter surface 165 connects the left end (the end which is not connected with the guide ring 151) of the lower left guide surface 163 and the upper end of the upper left guide surface 161. The left perimeter surface 165 has substantially the same radius as the substrate 91. The left guide member 160 has a first engaging recess 166 in an upper part and a second engaging recess 167 in a lower part. Both the first engaging recess 166 and the second engaging recess 167 are circular holes which engage with the engaging clutch convex portion 128 of the rotating body 90. A guide edge 168 of the left guide member 160 has substantially the same perimeter as the coin C and is substantially coaxial with the first engaging recess 166. An outer diameter 169 between the first engaging recess 166 and the second engaging recess 167 is smaller than the outer diameter of the left perimeter surface 165. The second coin containing section 154 is formed by the upper right guide surface 156 and the upper left guide surface 161 in the switching member 150.

The switching member 150 is rotatably attached to the rotating body 90. When the first engaging recess 166 engages with the engaging clutch convex portion 128 of the rotating body 90, the upper right guide surface 156 of the right guide member 155 and the upper right guide surface 110 of the right guide member 92 share substantially the same surface, and the upper left guide surface 161 of the left guide member 160 and the upper left guide surface 120 of the left guide member 93 share substantially the same surface. At that time, the coin containing section 135 is formed by overlapping the first coin containing section 140 in the rotating body 90 and the second coin containing section 154 in the switching member 150. The right perimeter surface 159 of the right guide member 155 is overlaid by an inner surface of a curved stopper piece 115 of the rotating body 90.

When the second engaging recess 167 is engaging with the engaging clutch convex portion 128 of the rotating body 90, the left guide member 160 closes the first coin containing section 140. Thus, the second coin containing section 154 comes off the first coin containing section 140 of the rotating body 90, and only the first coin containing section 140 constitutes the coin containing section 135. The guide edge 168 of the left guide member 160 overlaps with the perimeter of the coin C which is stored in the first coin containing section 140. The left perimeter surface 165 of the left guide member 160 is overlaid by an inner surface of the curved stopper piece 115 of the rotating body 90.

As shown in FIG. 7, a concave portion 171 in which the guide ring 151 of the switching member 150 rotatably fits is formed in the lid member 170. A perimeter surface 152 of the guide ring 151 moves in touch with an annular side 172 of the concave portion 171. An insertion hole 173 in which the center axis 145 of the rotating body 90 is inserted is formed in the center of the concave portion 171. The concave portion 171 has a partition member 175 which projects into the interior of the rotating body 90 from inside of the guide ring 151 and divides the first coin containing section 140 and the first coin passage 141. The partition member 175 is formed in a curved shape and is located so as to substantially close a left half of the lower part of the first coin containing section 140 when the rotating body 90 is rotated against the case 3 so that the coin slot 35 and the first coin containing section 140 face each other. Therefore, a coin stored in the first coin containing section 140 is prevented from going to the first coin passage 141 by the partition member 175. That is, the first coin containing section 140 can take positions where the other end 137 does and does not face the partition member 175 according to rotation of the rotating body 90.

A notch 180 substantially in the shape of an angular letter U is formed in the lid member 170 at an upper portion which faces the coin containing section 135. A long hole 181 along with a portion of the perimeter of the convex portion 171 is formed near the left side of the notch 180. A right axis receiving projection 182 and a left axis receiving projection 183 project from the upper end of the lid member 170 over the notch 180. A right axis receiving concave portion 185 is formed in the right axis receiving projection 182, and a left axis receiving concave portion 186 is formed in the left axis receiving projection 183. A spring receiving piece 187 is formed in the upper end of the left axis receiving projection 183 substantially at a right angle to the left axis receiving projection 183.

A pressing member 190 is attached over the notch 180 of the lid member 170. The pressing member 190 comprises a rocking member 191 which is received by the right axis receiving projection 182 and the left axis receiving projection 183, and a first press piece member 192 and a second press piece member 193 which are rockably attached to the rocking member 191. The rocking member 191 has a rocking board 195 which is substantially in the same shape as the notch 180. The rocking board 195 has a rocking axis 196 at an upper end, which is received by the right axis receiving concave portion 185 and the left axis receiving concave portion 186, and a clear hole 197 formed in the middle. The rocking board 195 has a pair of pivots 201 and 202 in the upper part, and the axis receiving board 203 is extended to the left of the rocking board 195. A pair of axis receiving parts 205 and 206 substantially in the shape of a letter C projects over the axis receiving board 203.

The first press piece member 192 comprises an axis receiving piece 210 substantially in the shape of an angular letter U which supports the pivots 201 and 202 of the rocking board 195, and a pressing piece 211 which protrudes downward from substantially a middle section of the axis receiving piece 210. A substantially middle section of the pressing piece 211 is bent toward the rocking board 195, and a tip 215 reaches the clear hole 197 of the rocking board 195 when the first press piece member 192 is attached to the rocking board 195. The axis receiving parts 212 and 213 substantially in the shape of a letter C are formed in both sides of the axis receiving piece 210 and rockably attached to the pivots 201 and 202 of the rocking member 191. Thus, the first press piece member 192 is enabled to rock against the rocking board 195. The pressing piece 211 is pressed toward the rocking board 195 by a spring member 214 looped around the pivot 202 of the rocking board 195. Therefore, the tip 215 projects into the clear hole 197.

The second press piece member 193 comprises a pressing piece 216 formed in the shape of a board, a pivot 217, and an elastic piece 219 in the shape of a spring board. The pivot 217 is formed in the upper part of the pressing piece 216, and is received by the axis receiving parts 205 and 206 of the axis receiving board 203 which extends from the left section of the rocking board 195. The elastic piece 219 is fixed to the pressing piece 216 by a screw so that a part 220 protrudes from the upper end of the pressing piece 216. A substantially middle section of the pressing piece 216 is bent toward the lid member 170, and a tip 218 reaches the long hole 181 of the lid member 170 when the pressing piece 216 is attached to the axis receiving board 203. Because both sides of the pivot 217 are attached to the axis receiving parts 205 and 206 of the rocking member 191, the second press piece member 193 is enabled to rock against the rocking board 195 and the lid member 170. Both sides of the rocking axis 196 of the rocking member 191 are rockably attached to the right axis receiving concave portion 185 and the left axis receiving concave portion 186 of the lid member 170. Thus, when the rocking member 191 is attached to the lid member 170, the part 220 of the elastic piece 219 of the second press piece member 193 which protrudes from the upper end of the pressing piece 216 contacts with the spring receiving piece 187 of the lid member 170, and the pressing piece 216 is pressed toward the lid member 170. Therefore, the tip 218 of the pressing piece 216 projects into the long hole 181 of the lid member 170.

A lock piece 222 is movably formed in the left part of the lid member 170 by a screw 221. When rotated counterclockwise, the lock piece 222 engages with the axis receiving board 203 and prevents movement of the rocking member 191. When movement of the rocking member 191 is barred, the tip 215 of the pressing piece 211 of the first press piece member 192 projects through the clear hole 197 and the notch 180 into the coin containing section 135. At the same time, the tip 218 of the pressing piece 216 of the second press piece member 193 projects through the long hole 181 and presses the left guide member 160 of the switching member 150.

As shown in FIG. 2, a columnar axis of rotation 225 is fixed by a screw 226 to the center axis 145 of the rotating body 90 which is inserted through the insertion hole 173 of the lid member 170 so as to be coaxial with the center axis 145. A disk-shaped engaged member 228 is formed in the axis of rotation 225 substantially at right angles to the axis of rotation 225. The engaged member 228 is substantially coaxial with the axis of rotation 225, and a part of the engaged member 228 is cut in a straight line, which forms an engaged part 230.

As shown in FIG. 1, a positioning device 240 is formed on the lid member 170. The positioning device 240 comprises an engaging member 231 in the shape of a long thin plate and a third elastic member 241. The engaging member 231 is attached to the lid member 170 by a screw 233 so as to be able to slide on the surface of the lid member 170. An engaging clutch edge 235 is formed in a straight line in the middle, and a hook 237 substantially in the shape of a letter L is formed in the lower part 236 of the engaging member 231. An end 242 of the spring-like third elastic member 241 is hooked on the hook 237. The other end 243 of the third elastic member 241 is fixed to the lid member 170 by a screw 245. The engaging clutch edge 235 of the engaging member 231 is pressed toward the engaging direction (clockwise in FIG. 1) by the third elastic member 241. The engaging clutch edge 235 presses the engaged part 230 of the engaging member 228 and positions the axis of rotation 225, the center axis 145, and the rotating body 90.

As shown in FIG. 2, the axis of rotation 94 of the rotating body 90 is received by an axis hole 20 of the case 3, and a tip part 98 protrudes from the axis hole 20. A handle 250 is fixed to the tip part 98 of the rotating body 94. A fixed axis 251 is formed substantially at the center of the handle 250, and a mounting hole 252 is formed in the fixed axis 251. The tip part 98 of the rotating body 90 is inserted into the mounting hole 252, and the handle 250 is fixed by a screw 253 so that it does not come off from the tip part 98 of the rotating body 90.

In the coin identifying device 1, the rotating body 90 is stored in the storage room 29 of the case 3, the axis of the rotation 94 is received in the axis hole 20 of the case 3, and the center axis 145 is received in the insertion hole 173 of the lid member 170. A guide shaft 106 of the rotating body 90 moves inside of a concave gap 21 of the case 3. As shown in FIG. 8, the guide piece 148 is engaged with a first guide groove 75 and a second guide groove 76, so dislocation of the rotating body 90 within the case 3 is prevented. The guide ring 151 fits and rotates in the concave portion 171 of the lid member 170, and the switching member 150 is positioned by engaging the first engaging recess 166 with the engaging clutch convex portion 128 of the rotating body 90. In this state, the second coin containing section 154 of the switching member 150 and the first coin containing section 140 of the rotating body 90 overlap and form the coin containing section 135. The engaging clutch edge 235 of the engaging member 231 is pressed to the engaged part 230 of the engaged member 228 formed in the axis of rotation 225 by the third elastic member 241, so that the rotating body 90 is positioned. That is, the rotating body 90 is positioned by the positioning device 240 at a position (initial position) where the coin containing section 135 and the coin slot 35 face each other and the coin C inserted from the coin slot 35 is stored directly in the coin containing section 135.

When the axis receiving board 203 engages with the lock piece 222, the rocking member 191 is prevented from moving, the tip 215 of the pressing piece 211 projects through the clear hole 197 and the notch 180 into inside of the coin containing section 135, and the tip 218 of the pressing piece 216 projects through the long hole 181 and presses against the left guide member 160 of the switching member 150.

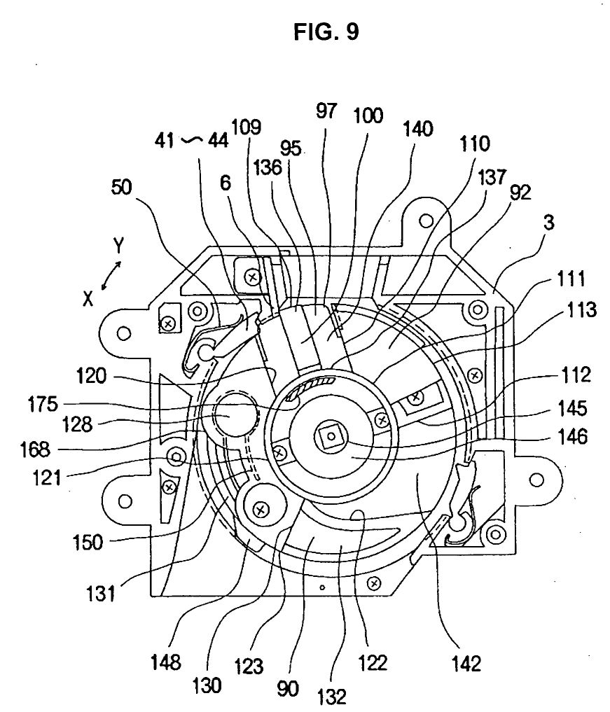

In the state described in FIG. 8, i.e., when the rotating body 90 is at the initial position, if the handle 250 is operated and the rotating body 90 is rotated in one direction (X direction; counterclockwise), the rotating body 90 cannot be moved further, since the engaging clutch edge 47 of the stop claw members (the first locking member) 41-44 stops the first stopping edge 116 of the stopper piece 115. Also, as shown in FIG. 9, the rotating body 90 cannot be moved further, since the upper end 109 of the engaging clutch piece 100 of the rotating body 90 engages with the side 6 of the case 3 before the engaging clutch edge 47 of the stop claw members (the first locking member) 41-44 stops the first stopping edge 116 of the stopper piece 115.

When four (which is the correct number of coins) fake coins which have the same thickness as a real coin C but have a smaller diameter than the real coin C are inserted from the coin slot 35 and stored in the coin containing section 135, the engaging clutch piece 100 of the rotating body 90 no longer prevents rotation of the rotating body 90, since the upper end 109 of the engaging clutch piece 100 is moved to the position where it does not engage with the side 6 of the body 2 by the four fake coins. However, since the diameter of the fake coins is smaller than the real coin, the fake coins cannot move the stop claw members (the first locking member) 41-44 opposite to the stopping direction due to the elasticity of the first elastic member 50, so the rotating body 90 cannot be rotated further, since the engaging edge 47 of the stop claw members (the first locking member) 41-44 stops the first stopping edge 116 of the stopper piece 115. Even if only one is a fake coin and the other three are real coins, one of the stop claw members (the first locking members) 41-44 located where the fake coin is located can prevent rotation.

If four fake coins which have the same diameter as the real coin C but are thinner than the real coin C are inserted from the coin slot 35 and stored in the coin containing section 135, rotation of the rotating body 90 is prevented by the engaging clutch piece 100 of the rotating body 90, since the four fake coins cannot move the upper end 109 of the engaging clutch piece 100 to a position where it does not engage with the side 6 of the body 2.

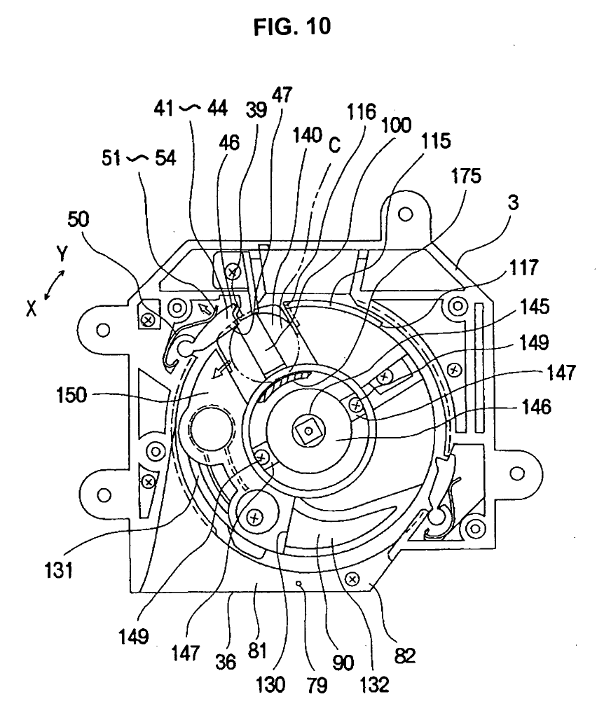

When four real coins C are inserted from the coin slot 35, the four real coins C are stored in the coin containing section 135. The four real coins C sit on the partition member 175. That is, when the rotating body 90 is at the initial position where the coin slot 35 and the opening 85 of the body 2 face each other, the coin C inserted from the coin slot 35 is prevented from moving to the coin passage 143 by the partition member 175 and is stored in the coin containing section 135, since the partition member 175 is facing the other end 137 of the coin containing section 135. The rotating body 90 is moved to the position where the upper end 109 of the engaging clutch piece 100 does not engage with the side 6 of the body 2 by the four real coins C, because the four real coins in the coin containing section 135 are pressed by the tip 215 of the pressing piece 211. As shown in FIG. 10, when the handle 250 is operated and the rotating body 90 is rotated in one direction (X direction; counterclockwise), the four real coins C contact with the stop claw members (the first locking members) 41-44 and push the stop claw members (the first locking members) 41-44 toward the opposite of the stopping direction against the elasticity of the first elastic member 50. Thus, the engaging clutch edge 47 of the stop claw members (the first locking member) 41-44 does not stop the first stopping edge 116 of the stopper piece 115, and rotation of the rotating body 90 is not prevented.

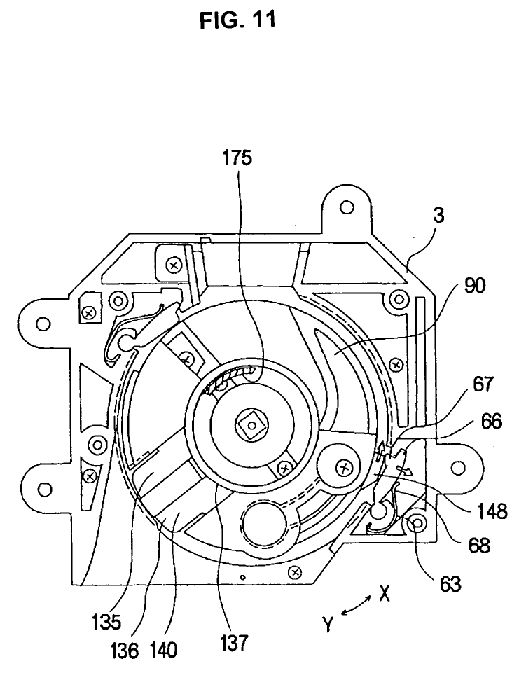

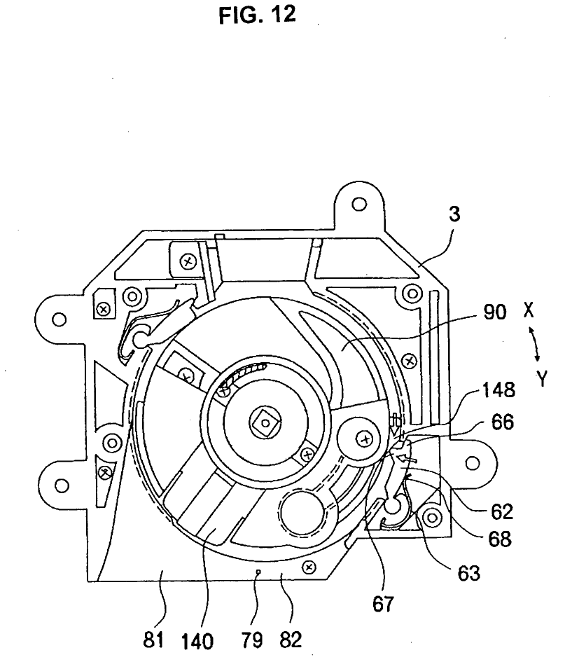

If the rotating body 90 is rotated about 90 degrees in one direction (X direction; counterclockwise), the upper left guide surfaces 120 and 161 of the coin containing section 135 become substantially horizontal, and the four real coins C come off the partition member 175 and sit on the upper left guide surfaces 120 and 161. As shown in FIG. 11, if the rotating body 90 is rotated further, a stopping projection 67 of the stop claw member (the second locking member) 62 does not stop the guide piece 148, and rotation of the rotating body 90 is not prevented, since the guide piece 148 of the rotating body 90 contacts with the stop claw member (the second locking member) 62 and pushes the stop claw member (the second locking member) 62 opposite to the stopping direction against the elasticity of the second elastic member 63. As shown in FIG. 12, if the rotating body 90 is rotated further and the guide piece 148 of the rotating body 90 passes the stop claw member (the second locking member) 62, rotation of the rotating body 90 to the other direction (Y direction; clockwise) is prevented, since the guide piece 148 is stopped by a stopping projection 67 of the stop claw member (the second locking member) 62. If the coin containing section 135 of the rotating body 90 is inclined downwardly, the four real coins C fall to the first outlet (coin outlet) 81 via the opening 85 due to their weight.

That is, when the rotating body 90 is at the initial position where the coin slot 35 and the opening 85 of the body 2 counter and when the rotating body 90 is rotated from the initial position in one direction, the coin C inserted from the coin slot 35 is prevented from moving to the coin passage 143, since the partition member 175 faces the other end 137 of the coin containing section 135. Thus, the coin C is stored in the coin containing section 135. When the rotating body 90 is rotated 90 degrees or more from the initial position in one direction, the coin C stored in the coin containing section 135 is discharged from the coin outlet 81 via the opening 85 due to its own weight.

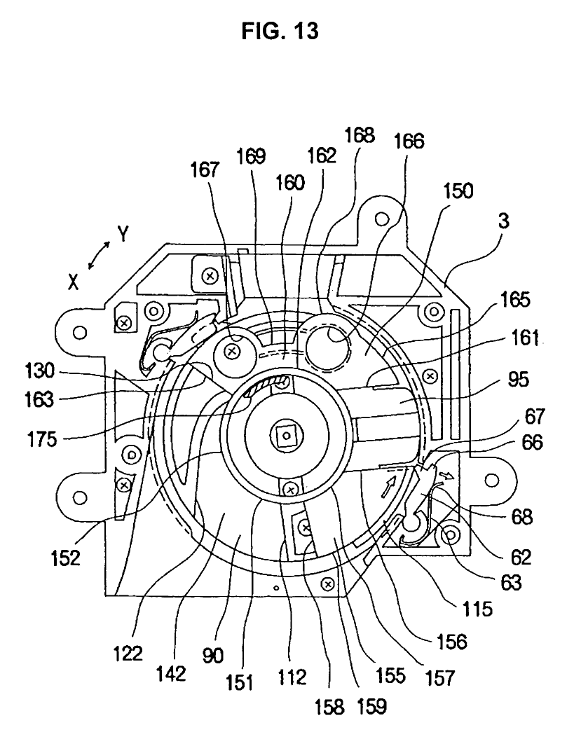

As shown in FIG. 13, if the rotating body 90 is rotated about 270 degrees in one direction (X direction; counterclockwise), the stopping projection 67 of the stop claw member (the second locking member) 62 does not stop the stopper piece 115, and rotation of a rotating body 90 is not prevented, since the first stopping edge 116 of the stopper piece 115 contacts with the stop claw member (the second locking member) 62 and pushes the stop claw member (the second locking member) 62 opposite to the stopping direction against the elasticity of the second elastic member 63. As shown in FIG. 8, if the rotating body 90 is rotated 360 degrees in one direction (X direction; counterclockwise), the rotating body 90 is positioned where the coin containing section 135 and the coin slot 35 face each other and where the coin C inserted from the coin slot 35 is stored directly in the coin containing section 135 by the positioning device 240 (initial position).

Next, the number of the real coins C to be inserted will be changed. As shown in FIG. 1, if the screw 221 is loosened and the lock piece 222 is rotated clockwise, the lock piece 222 moves away from the axis receiving board 203, and the rocking member 191 can now rock. If the rocking member 191 is raised and the engaging clutch convex portion 128 is pressed by a finger through the long hole 181, the engaging clutch convex portion 128 separates from the first engaging recess 166 of the switching member 150. As shown in FIG. 6, if the switching member 150 is rotated in the other direction (Y direction; clockwise) at this time, the engaging clutch convex portion 128 engages with the second engaging recess 167, and the rotating body 90 is positioned. If the second engaging recess 167 engages with the engaging clutch convex portion 128 of the rotating body 90, the second coin containing section 154 separates from the first coin containing section 140 of the rotating body 90, and the left guide member 160 overlaps with the first coin containing section 140 so that the coin containing section 135 only comprises the first coin containing section 140. At this time, since the diameter of the guide edge 168 of the left guide member 160 is substantially the same as that of the coin C, the guide edge 168 overlaps with the periphery of the coin C stored in the first coin containing section 140. Also, the tip 215 of the pressing piece 211 of the first press piece member 192 projects into the first coin containing section 140 through the clear hole 191 of the rocking board 195, the notch 180 in the lid member 170, and the first engaging recess 166 of the left guide member 160.

When two real coins C are inserted from the coin slot 35, the two real coins C are stored in the coin containing section 135 (the first coin containing section 140). The two real coins C sit on the partition member 175. That is, when the rotating body 90 is at the initial position where the coin slot 35 and the opening 85 of the body 2 meet, the coin C inserted from the coin slot 35 is prevented from moving to the coin passage 143 by the partition member 175 and is stored in the first coin containing section 140 (coin containing section 135), since the partition member 175 is facing the other end 137 of the first coin containing section 140 (coin containing section 135). At this time, the two real coins C are pressed by the engaging clutch piece 100 by the tip 215 of the pressing piece 211 of the first press piece member 192. Thus, the upper end 109 of the engaging clutch piece 100 moves to a position where it does not engage with the side 6 of the body 2. As shown in FIG. 10, if the handle 250 is operated and the rotating body 90 is rotated in one direction (X direction; counterclockwise), the two real coins C contact with the stop claw members (the first locking member) 43 and 44, and the guide edge 168 contacts with the stop claw members (the first locking member) 41 and 42 simultaneously. Since the stop claw members (the first locking member) 41-44 are moved to the opposite of the stopping direction against the elasticity of the first elastic member 50, the engaging clutch edge 47 of the stop claw members (the first locking member) 41-44 does not stop the first stopping edge 116 of the stopper piece 115, and rotation of the rotating body 90 is not prevented. The rotating body 90 is then rotated the rest of the way in a similar manner to when four coins are stored.

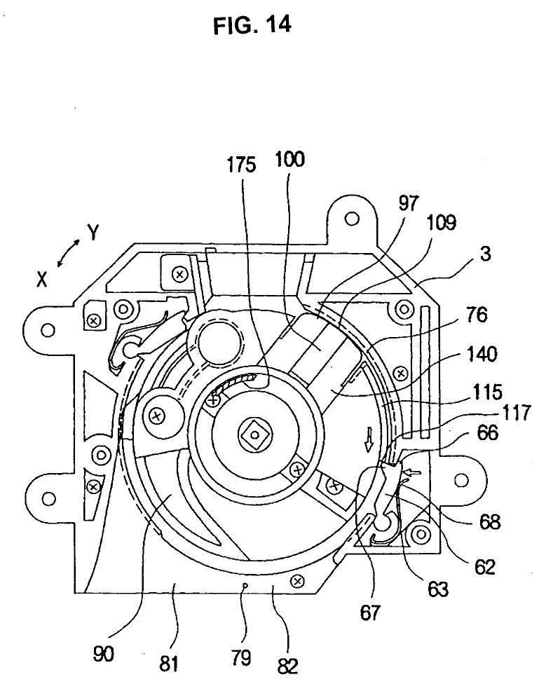

Next, the return of the coin C is explained below. If a coin C is inserted from the coin slot 35, the coin C is stored in the coin containing section 135. The coin C sits on the partition member 175. That is, when the rotating body 90 is at the initial position where the coin slot 35 and the opening 85 of the body 2 meet, the coin C inserted from the coin slot 35 is prevented from moving to the coin passage 143 by the partition member 175 and is stored in the first coin containing section 140 (coin containing section 135), since the partition member 175 is facing the other end 137 of the first coin containing section 140 (coin containing section 135). The coin C inserted does not have to be a real coin, and the number of coins does not have to be correct either. As shown in FIG. 14, if the handle 250 is operated and the rotating body 90 is rotated to the other direction (Y direction; clockwise), the upper left guide surfaces 120 and 161 (the upper left guide surface 120 only when the first engaging recess 166 overlaps with the first coin containing section 140 by rotation of the switching member 150) push the side of the coin C in the other direction (Y direction; clockwise). Then, the coin C is moved on the partition member 175 in the other direction (Y direction; clockwise). When the rotating body 90 is rotated about 15 degrees in the other direction (Y direction; clockwise), the coin C moves apart from the partition member 175, starts falling due to its own weight, and falls to the second outlet (coin-return opening) 82 through the first coin passage 141 and the second coin passage 142.

That is, when the rotating body 90 is rotated in the other direction from the initial position, the other end 137 of the coin containing section 135 does not face the partition member 175. Thus, movement of the coin C stored in the coin containing section 135 to the coin passage 143 is enabled, and the coin C is discharged from the second outlet (coin-return opening) 82 via the coin passage 143 due to its own weight.

After the rotating body 90 is rotated from the initial position in the other direction (Y direction: clockwise) and the coin C in the coin containing section 135 is dropped to the coin passage 143, the stop claw member (the second locking member) 62 is stopped by the second stopping edge 117 of the stopper piece 115 of the rotating body 90, and further rotation of the rotating body 90 in the other direction (Y direction; clockwise) is prevented.

As shown in FIG. 8, if the rotating body 90 is rotated in one direction (X direction; counterclockwise) to return to the initial position, the rotating body 90 is positioned where the coin containing section 135 is substantially straight up and the coin C inserted from the coin slot 35 is stored directly in the coin containing section 135.

The coin identifying device 1 is incorporated in an article dispensing machine, such as a capsule machine. If a coin C is inserted, the handle 250 is operated, and the rotating body 90 is rotated in one direction (X direction; counterclockwise), the rotation board of the article dispensing machine which is interlocked with the rotating body 90 transports an article such as a capsule to a dispensing outlet. The coin C falls from the first outlet (coin outlet) 81 and is stored in a coin storage box of the article dispensing machine. If the handle 250 is operated in the other way and the rotating body 90 is rotated in the other direction (Y direction; clockwise) after the coin is inserted in the coin identifying device 1, the coin C falls from the second outlet (coin-return opening) 82 and drops to the coin-return opening of the article dispensing machine.

When the correct number of the real coins C are not inserted in the coin identifying device 1 from the coin slot 35, even if the rotating body 90 is attempted to be rotated by operation of the handle 250, the stopping edge 116 of the rotating body 90 is stopped by one of the plurality of the locking members 41-44, and rotation of the rotating body 90 is prevented. Also, when a plurality of coins C including a fake coin with a smaller diameter than the real coin C are inserted from the coin slot 35 and stored in the coin containing section 135 of the rotating body 90, one of the locking members 41-44 cannot move opposite to the stopping direction because of the periphery of the fake coin, even if the rotating body 90 is attempted to be rotated by operation of the handle 250. Thus, the stopping edge 116 of the rotating body 90 is stopped by the locking members 41-44 which is located where the fake coin is, and rotation of the rotating body 90 is prevented. If the correct number of real coins C are inserted from the coin slot 35 and the plurality of the coins C are stored in the coin containing section 135 of the rotating body 90, when the handle 250 is operated and the rotating body 90 is rotated, the plurality of the locking members 41-44 move opposite to the stopping direction by contacting with the periphery of each real coin C at the time of rotation of the rotating body 90 and do not stop the stopping edge 116 of the rotating body 90. Therefore, rotation of the rotating body 90 is possible, and the plurality of the coins C in the coin containing section 135 can be discharged from the coin outlet 36.

The switching member 150 that changes the number of coins stored in the coin containing section 135 is rotatably provided in the rotating body 90. The coin containing section 135 comprises a first coin containing section 140 formed in the rotating body 90 and a second coin containing section 154 formed in the switching member 150. When the switching member 150 is rotated in one direction (X direction; counterclockwise) against the rotating body 90, the second coin containing section 154 overlaps with the first coin containing section 140 of the rotating body 90 so that the coin containing section 135 comprises the second coin containing section 154 and the first coin containing section 140. When the switching member 150 is rotated in the other direction (Y direction; clockwise) against the rotating body 90, the second coin containing section 154 separates from the first coin containing section 140 of the rotating body 90 so that the coin containing section 135 only comprises the first coin containing section 140. Therefore, the number of coins stored in the coin storing section 135 can be changed. In this way, the number of coins C to be inserted the coin identifying device 1 can be changed easily by the switching member 150.

When the second coin containing section 154 separates from the first coin containing section 140 of the rotating body 90 so that the coin containing section 135 only comprises the first coin containing section 140, the guide edge 168 of the switching member 150 moves the locking members 41-44 opposite to the stopping direction by contacting with the locking members 41-44 at the time of rotation of the rotating body 90. This can prevent the locking members 41-44 from stopping the stopping edge 116 of the rotating body 90.

When the correct number of real coins C are not stored in the coin containing section 135 or when a fake coin that has a different thickness from a real coin C is stored in the coin containing section 135, the engaging clutch piece 100 prevents rotation of the rotating body 90 by engaging with one side 6 of the body 2 at the time of rotation of the rotating body 90. When the correct number of the real coins C are stored in the coin containing section 135, the engaging clutch piece 100 moves opposite to the stopping direction, does not engage with the side 6 of the body 2 at the time of rotation of the rotating body 90, and does not prevent the rotation of the rotating body 90. In this way, the coin identifying device 1 can also detect the thickness of a coin C.

When the second coin containing section 154 overlaps with the first coin containing section 140 of the rotating body 90 so that the coin containing section 135 comprises the second coin containing section 154 and the first coin containing section 140 by rotating the switching member 150 in one direction (X direction; counterclockwise) against the rotating body 90, the switching member 150 is positioned so that the engaging convex portion 128 or the engaging recess engages with the first engaging recess 166 or the first engaging convex portion. When the second coin containing section 154 separates from the first coin containing section 140 of the rotating body 90 so that the coin containing section 135 only comprises the first coin containing section 140 by rotating the switching member 150 to the other direction (Y direction; clockwise) against the rotating body 90, the switching member 150 is positioned so that the engaging convex portion 128 or the engaging recess engages with the second engaging recess 167 or the second engaging convex portion. In this way, the coin identifying device 1 can securely maintain the positions switched by the switching member 150.

The coin identifying device 1 is designed so that the coin C inserted from the coin slot 35 is stored in the coin containing section 135 of the rotating body 90 which stands by at the initial position. When a coin C is stored in the coin containing section 135 of the rotating body 90, the coin C is prevented from falling to the coin passage 143 by the partition member 175 which partitions the coin containing section 135 and the coin passage 143 and is stored in the coin containing section 135. When a real coin C is not inserted from the coin slot 35 or a fake coin that has a smaller diameter than a real coin C is inserted from the coin slot 35, the first locking members 41-44 stop the first stopping edge 116 of the rotating body 90, and rotation of the rotating body 90 in one direction (X direction; counterclockwise) from the initial direction by operation of the handle 250 is prevented. When the real coin C is inserted from the coin slot 35 and stored in the coin containing section 135 of the rotating body 90, the first locking members 41-44 move opposite to the stopping direction by contacting with a periphery of the real coin C. Thus, the rotation of the rotating body 90 in one direction (X direction; counterclockwise) becomes possible since the first locking members 41-44 do not stop the first stopping edge 116 of the rotating body 90, and the coin C in the coin containing section 135 is led along the partition member 175 and can be discharged from the coin outlet 36. When the coin C is stored in the coin containing section 135 of the rotating body 90, if the rotating body 90 is rotated from the initial position to the other direction (Y direction; clockwise) by operation of the handle 250, the coin C moves away from the partition member 175, falls to the coin passage 143, and is discharged from the coin outlet 36. Therefore, the coin identifying device 1 can discharge an article when the rotating body 90 is rotated in one direction (X direction; counterclockwise), and can return the coin C when the rotating body 90 is rotated in the other direction (Y direction; clockwise). Thus, the coin identifying device 1 can be manufactured inexpensively since it does not need a complex structure such as a return button.

Since the second locking member 62 stops the second stopping edge 117 of the rotating body 90 and prevents the rotation of the rotating body 90 in the other direction (Y direction; clockwise) after the rotating body 90 is rotated from the initial position in the other direction (Y direction; clockwise) and the coin C in the coin containing section 135 falls to the coin passage 143, the coin identifying device 1 can prevent superfluous reverse rotation. Since the positioning device 240 can position the rotating body 90 in the initial position, the coin identifying device 1 can prevent the rotating body 90 from rotating needlessly, and the rotating body 90 can always stand by in the initial position.

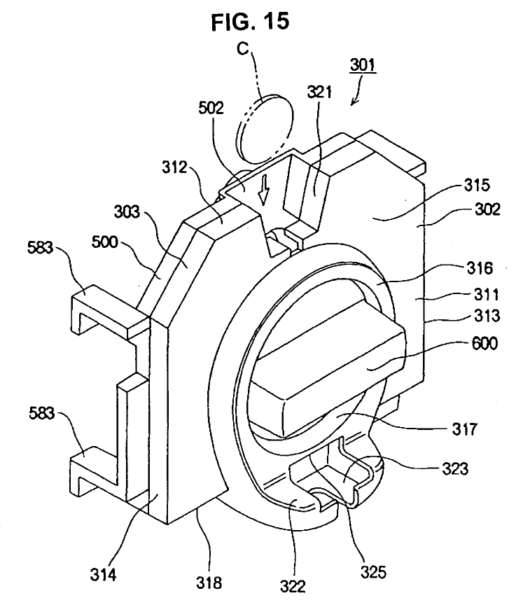

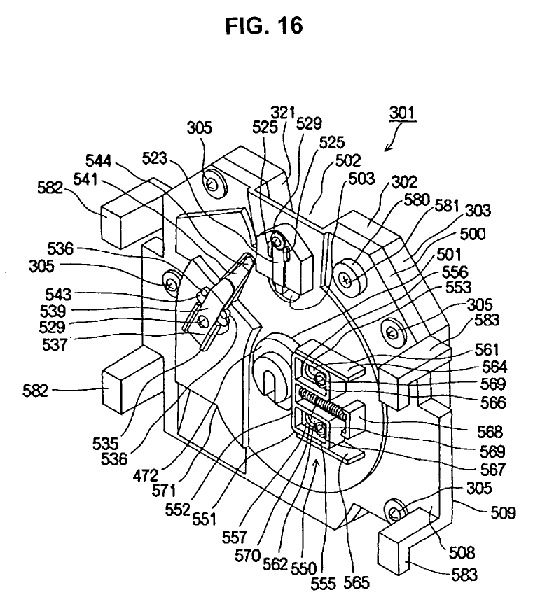

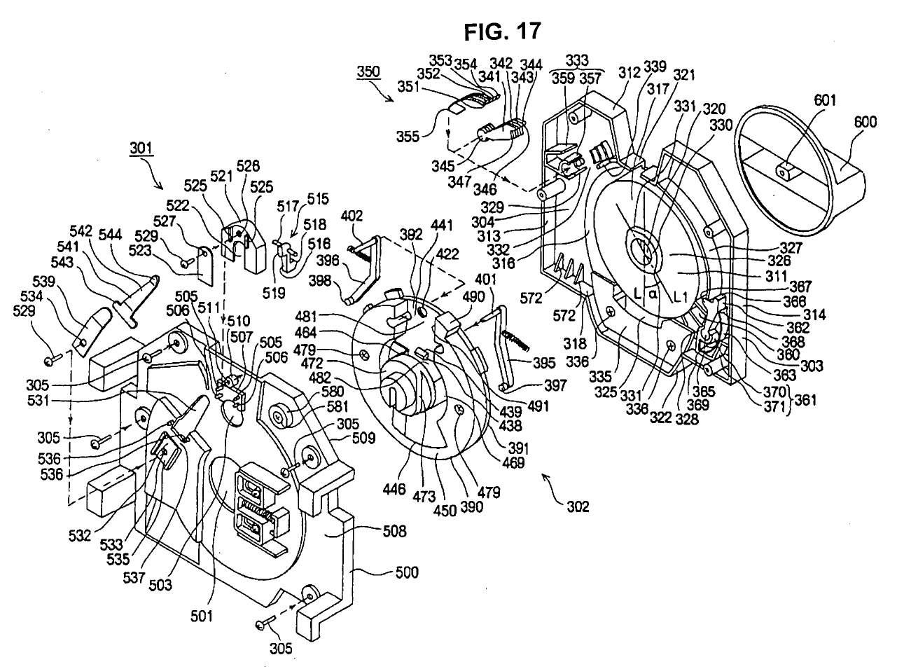

Another embodiment of the coin identifying device is explained below. The coin identifying device 301 has a body 302. As shown in FIGS. 15 and 16, a coin slot 502 is formed in the upper part, a coin outlet 571 is formed in the lower part, and a rotating body 390 which is operated by a handle 600 and which is rotatably provided inside the body 302. As shown in FIG. 17, a coin containing section 481 which can store a plurality of coins C in a stack inserted from the coin slot 502 in the rotating body 390. A plurality of locking members 341-344 corresponding to the correct number of coins C are provided in the body 302.

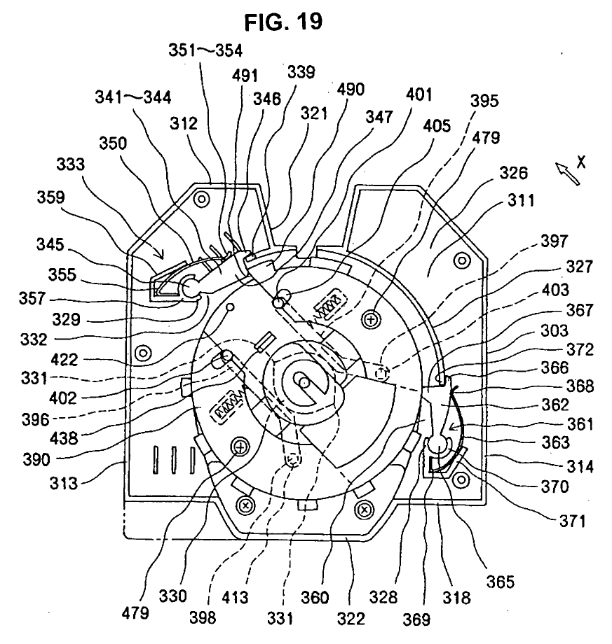

As shown in FIG. 19, the locking members 341-344 are each pressed toward the stopping direction by an elastic member 350. When the correct number of real coins C are not stored in the coin containing section 481 or when a fake coin which has a smaller diameter than the real coin C is stored in the coin containing section 481, the locking members 341-344 stop a stopping edge 491 of the rotating body 390 at the time of rotation of the rotating body 390 and prevent the rotation of the rotating body 390.

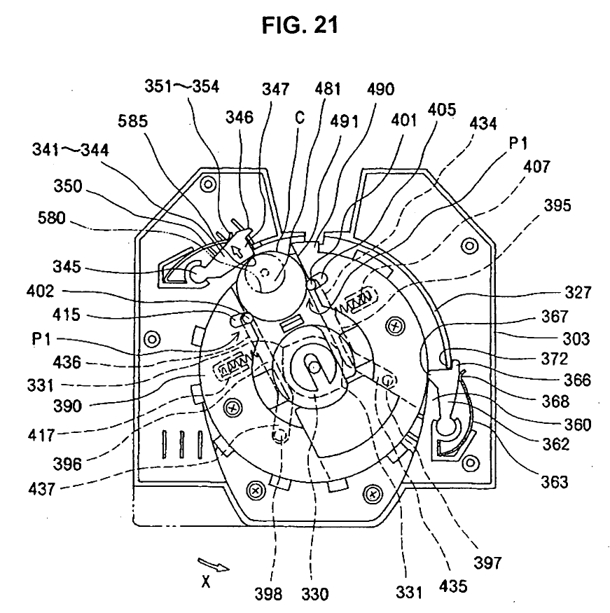

As shown in FIG. 21, when the correct number of the real coins C are stored in the coin containing section 481, the locking members 341-344 move opposite to the stopping direction by contacting the periphery of each real coin C at the time of rotation of the rotating body 390. Thus, since the stopping edge 491 of the rotating body 390 is not stopped, the rotation of the rotating body 390 becomes possible, and the plurality of the coins C in the coin containing section 481 can be discharged from the coin outlet 571.

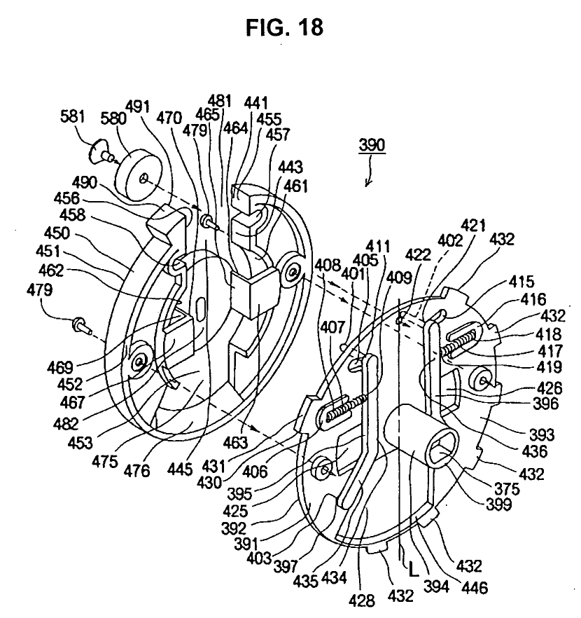

As shown in FIG. 18, a changing member 580 which changes the number of coins to be stored is attached to a mounting part 422 formed in the coin containing section 481 of the rotating body 390. As shown in FIG. 16, the changing member 580 is attached to one side of the body 302 and is detachable therefrom.

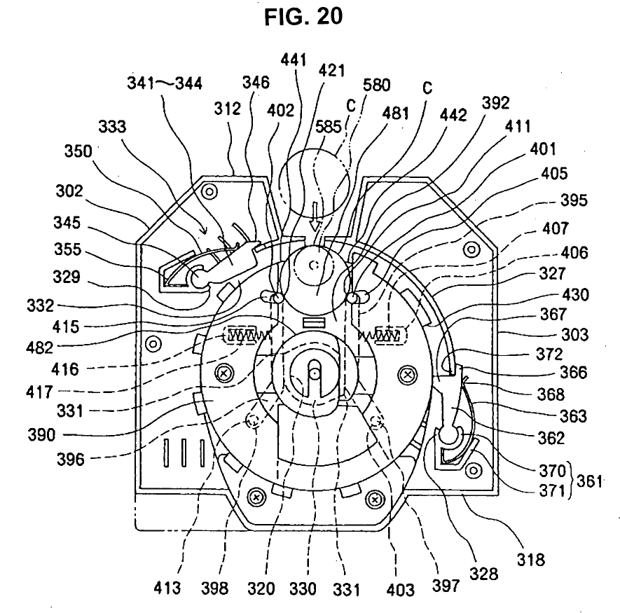

The coin slot 502 is formed in the upper part, the coin outlet 571 and the coin-return opening 325 are formed in the lower part, and the rotating body 390 which is rotated by the handle 600 is provided inside the body 302 of the coin identifying device 301. As shown in FIG. 20, the rotating body 390 has the coin containing section 481, and stands by at an initial position where the coin C inserted from the coin slot 502 is stored in the coin containing section 481. As shown in FIG. 17, the first locking members 341-344 are pressed toward the stopping direction by the first elastic member 350.

As shown in FIG. 19, when the correct number of real coins C are not stored in the coin containing section 481 or when a fake coin which has a smaller diameter than the real coin C is stored in the coin containing section 481, the locking members 341-344 stop a stopping edge 491 of the rotating body 390 at the time of rotation of the rotating body 390 in one direction (X direction; counterclockwise) and prevent further rotation of the rotating body 390.

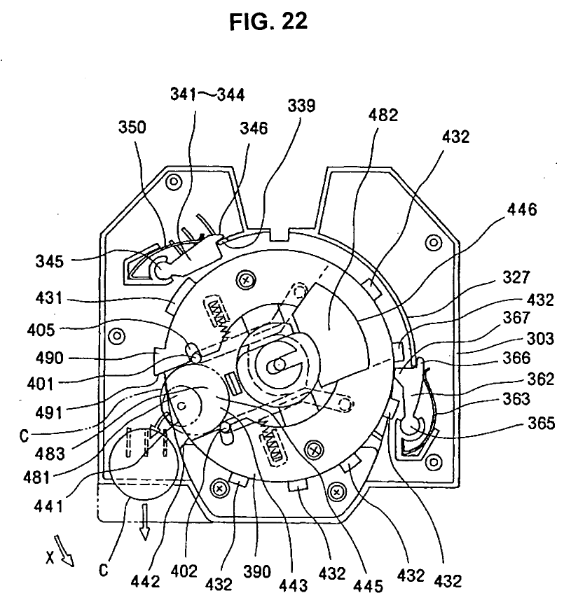

As shown in FIG. 21, when the real coins C are stored in the coin containing section 481, the first locking members 341-344 move opposite to the stopping direction by contacting the periphery of the real coins C at the time of rotation of the rotating body 390 in one direction (X direction; counterclockwise). Thus, as shown in FIG. 22, the rotation of the rotating body 390 becomes possible since the first stopping edge 491 of the rotating body 390 is not stopped, and the coins C in the coin containing section 481 can be discharged from the coin outlet 571.

As shown in FIG. 20, a coin passage 482 which is connected with the coin containing section 481 and in which a coin C falls to the coin-return opening 325 is formed in the rotating body 390. Partition members 395 and 396 which partition the coin containing section 481 and the coin passage 482 are formed in the body 302.

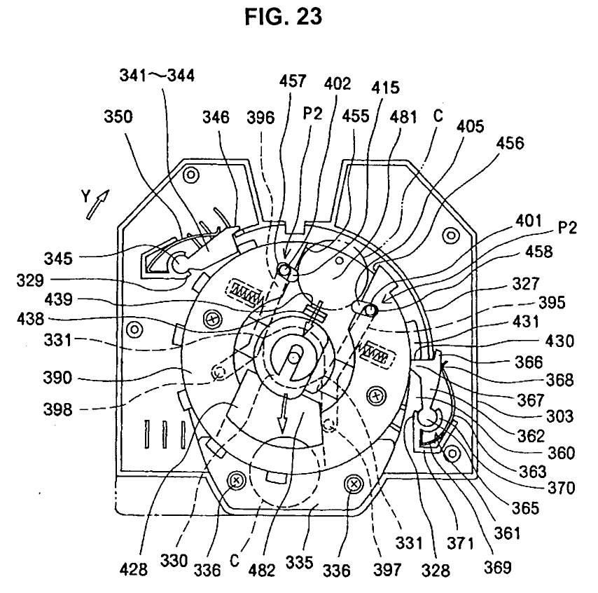

As shown in FIG. 21, the partition members 395 and 396 partition the coin containing section 481 and the coin passage 482 and prevent the coin C in the coin containing section 481 from falling to the coin passage 482 at the time of rotation of the rotating body 390 from the initial position to one direction (X direction; counterclockwise). As shown in FIG. 23, at the time of rotation of the rotating body 390 from the initial position to the other direction (Y direction; clockwise), the partition members 395 and 396 no longer partition the coin containing section 481 and the coin passage 482 so that the coin C in the coin containing section 481 falls to the coin passage 482 and is discharged from the coin outlet 325.

As shown in FIG. 20, the coin passage 482 which is connected with the coin containing section 481 and in which the coin C falls to the coin-return opening 325 is formed in the rotating body 390. Moreover, the partition members 395 and 396 which partition the coin containing section 481 and the coin passage 482 are formed in the rotating body 390. The partition members 395 and 396 can move to a partitioning position P1 to prevent the coin C from falling and a non-partitioning position P2 not to prevent the coin C from falling, and are pressed toward the partitioning position P1 by fourth elastic members 407 and 417.

As shown in FIG. 21, an engaging member 331, 331 is formed on the body 302. At the time of rotation of the rotating body 390 in one direction (X direction; counterclockwise) from the initial position, the engaging members 331, 331 do not engage with the partition members 395 and 396 of the partitioning position P1 and prevent the coin C in the coin containing section 481 from falling to the coin passage 482. And as shown in FIG. 23, at the time of rotation of the rotating body 390 from the initial position to the other direction (Y direction; clockwise), the engaging member 331, 331 moves the partition members 395 and 396 to the non-partitioning position P2 against the elasticity of the fourth elastic members 407 and 417 by engaging with the partition members 395 and 396 at the partitioning position P1 so that the coin C in the coin containing section 481 falls to the coin passage 482 and is discharged from the coin-return opening 325.

As shown in FIG. 20, the coin passage 482 which is connected with the coin containing section 481 and in which a coin C falls to the coin-return opening 325 is formed in the rotating body 390. Moreover, a pair of coin stoppers 395 and 396 are provided between the coin containing section 481 and the coin passage 482. The pair of the coin stoppers 395 and 396 can move to a closed position P1 to prevent the coin C from falling and an open position P2 to allow the coin to fall, and are pressed toward the closed position by fourth elastic members 407 and 417.

As shown in FIG. 21, the engaging members 331, 331 are formed on the body 302. At the time of rotation of the rotating body 390 in one direction (X direction; counterclockwise) from the initial position, the engaging members 331, 331 do not engage with the pair of the coin stoppers 395 and 396 in the closed state and prevent the coin C in the coin containing section 481 from falling to the coin passage 482. And as shown in FIG. 23, at the time of rotation of the rotating body 390 from the initial position in the other direction (Y direction; clockwise), the engaging members 331, 331 move the pair of the coin stoppers 395 and 396 in the closed state to the open position P2 against the elasticity of the fourth elastic members 407 and 417 by engaging with the pair of the coin stoppers 395 and 396 so that the coin C in the coin containing section 481 falls to the coin passage 482 and is discharged from the coin-return opening 325.

As shown in FIG. 20, the second locking member 362 is pressed toward the stopping direction by the second elastic member 363 in the body 302.

As shown in FIG. 23, the second locking member 362 stops the second stopping edge 430 of the rotating body 390 and prevents rotation of the rotating body 390 in the other direction (Y direction; clockwise) after the rotating body 390 is rotated from the initial position in the other direction (Y direction; clockwise) and the coin C in the coin containing section 481 falls to the coin passage 482. As shown in FIG. 16, the positioning device 550 which positions the rotating body 390 at the initial position is formed in the body 302 of the coin identifying device 301.

The positioning device 550 comprises an engaging member 551 which engages with the engaged part 473 formed in the rotating body 390 or in the axis of rotation 472 provided substantially at the center of the rotating body 390, and the third elastic member 570 which presses the engaging member 551 toward the engaging direction.

The coin identifying device 301 comprises: the body 302 which has the coin slot 502 in the upper part and the coin outlet 571 and the coin-return opening 325 in the lower part; the rotating body 390 rotatably provided inside the body 302; the opening 441 provided at a periphery of the rotating body 390; the coin containing section 481 provided in the rotating body 390 and one end 442 of which is connected with the opening 441; the coin passage 482 provided in the rotating body 390, one end 445 of which is connected with the other end 443 of the coin containing section 481, and the other end 446 of which is connected with the exterior of the rotating body 390; the partition members 395 and 396 provided in the body 390, which partition the coin containing section 481 and the coin passage 482, which can move to the partitioning position P1 to prevent the coin C from falling and the non-partitioning position P2 to allow the coin C to fall, and which is pressed toward the partitioning position P1 by the fourth elastic members 407 and 417; and the engaging members 331, 331 provided in the body 302, which prevent the coin C in the coin containing section 481 from falling to the coin passage 482 by not engaging with the partition members 395 and 396 at the partitioning position P1 at the time of rotation of the rotating body 390 from the initial direction in one direction (X direction; counterclockwise), and which engage with and move the partition members 395 and 396 at the partitioning position P1 to the non-partitioning position P2 against the elasticity of the fourth elastic members 407 and 417 so that the coin C in the coin containing section 481 falls to the coin passage and is discharged from the coin-return opening 325.

When the rotating body 390 is at the initial position where the coin slot 502 and the opening 441 of the body 302 meet or when the rotating body 390 is rotated from the initial position in one direction (X direction; counterclockwise), the coin C inserted from the coin slot 502 is prevented from moving to the coin passage 482 and stored in the coin containing section 481, because the partition members 395 and 396 are at the partitioning position P1 without engaging with the engaging member 331, 331. When the rotating body 390 is rotated 90 degrees or more from the initial position in one direction, the coin C stored in the coin containing section 481 is discharged from the coin outlet 571 via the opening 441 due to its own weight. When the rotating body 390 is rotated from the initial position in the other direction (Y direction; clockwise), the coin C stored in the coin containing section 481 moves to the coin passage 482 and is discharged from the coin-return opening 325 through the coin passage 482 due to its own weight, since the partition members 395 and 396 engage with the engaging member 331, 331 and move to the non-partitioning position P2.

The coin identifying device 301 comprises: the body 302 which has the coin slot 502 in the upper part and the coin outlet 571 and the coin-return opening 325 in the lower part; the rotating body 390 rotatably provided inside the body 302; the opening 441 provided at a periphery of the rotating body 390; the coin containing section 481 provided in the rotating body 390 and one end 442 of which is connected with the opening 441; the coin passage 482 provided in the rotating body 390, one end 445 of which is connected with the other end 443 of the coin containing section 481, and the other end 446 of which is connected with the exterior of the rotating body 390; the pair of coin stoppers 395 and 396 provided in the rotating body 390, which close an opening between the coin containing section 481 and the coin passage 482, which can move to the closed position P1 to prevent the coin C from falling and the open position P2 to allow the coin C to fall, and which is pressed toward the closed position P1 by the fourth elastic members 407 and 417; and the engaging member 331, 331 provided in the body 302, which prevents the coin C in the coin containing section 481 from falling to the coin passage 482 by not engaging with the pair of the coin stoppers 395 and 396 in the closed state at the time of rotation of the rotating body 390 from the initial direction in one direction (X direction; counterclockwise), and which engages with and move the pair of the coin stoppers 395 and 396 in the closed state to the opening position P2 against the elasticity of the fourth elastic members 407 and 417 so that the coin C in the coin containing section 481 falls to the coin passage 482 and is discharged from the coin-return opening 571.

When the rotating body 390 is at the initial position where the coin slot 502 and the opening 441 of the body 302 meet or when the rotating body 390 is rotated from the initial position in one direction (X direction; counterclockwise), the coin C inserted from the coin slot 502 is prevented from moving to the coin passage 482 and stored in the coin containing section 481, because the pair of coin stoppers 395 and 396 are at the closed position P1 and do not engage with the engaging members 331, 331. When the rotating body 390 is rotated 90 degrees or more from the initial position in one direction (X direction; counterclockwise), the coin C stored in the coin containing section 481 is discharged from the coin outlet 571 via the opening 441 due to its own weight. When the rotating body 390 is rotated from the initial position in the other direction (Y direction; clockwise), the coin C stored in the coin containing section 481 moves to the coin passage 482 and is discharged from the coin-return opening 325 through the coin passage 482 due to its own weight, since the pair of the coin stoppers 395 and 396 engage with the engaging member 331, 331 and move to the open position P2.

A more detailed explanation is as follows. As shown in FIGS. 15 and 16, the coin identifying device 302 has the body 302 formed in the shape of a rectangular box. As shown in FIG. 17, the body 302 comprises the case 303 and a lid member 500 attached in the rear of the case 303 by a fixing device 305 such as a screw, and the rotating body 390 is rotatably provided inside. The case 303 has a front wall 311, a top wall 312 formed in the upper part of the front wall 311, a left wall 313 formed in the left part of the front wall 311, and a right wall 314 formed in the right part of the front wall 311, and a lower wall 318 formed in the lower part of the front wall 311. The rear part of the case 303 is open. A rear releasing part 304 of the case 303 is closed by the lid member 500. The heights of the top wall 312, the left wall 313, the right wall 314, and the lower wall 318 are substantially the same.

As shown in FIG. 15, a circular concave portion 317 with a section substantially in the shape of an angular letter U is formed on a front surface 315 of the front wall 311 with an annular projection band 316. As shown in FIG. 17, an axis hole 320 is formed substantially at the center of the circular concave portion 317 at the back of the front wall 311. A concave portion 321 substantially in the shape of a reverse trapezoid is formed substantially at the center of the upper wall 312. As shown in FIG. 15, a coin return part 322 is formed with a coin return concave portion 323 at the center of the lower wall 318. A coin return opening 325 connected with the coin return concave portion 323 is formed in the lower part of the front wall 311. As shown in FIG. 17, a guide member 335 which guides the coin C to the coin return opening 325 is attached at a rear surface 326 of the front wall 311 by a fixing device 336, such as a screw.

An annular guide 330 is formed at a periphery of the axis hole 320 on the rear surface 326 of the front wall 311. A pair of engaging members 331, 331 is formed facing each other at the outer end of the guide 330. The engaging member 331 substantially in the shape of a triangle projects at the outer end of the guide 330. The line L1 which connects the peak of the pair of the engaging members 331, 331 is disposed at a certain angle α to the vertical line L. In this embodiment, a is about 60 degrees.

A guide wall 327 in the shape of a semicircle is formed on the rear surface 326 of the front wall 311 substantially centering around the axis hole 320. As shown in FIGS. 19 and 20, the guide wall 327 extends from a right end 328 located near the lower wall 318 to a left end 329 located near the upper wall 312 (hereafter, each of “right” and “left” in this embodiment shall mean the “right” and “left” viewed from the rear surface 326).

As shown in FIGS. 17 and 19, a notch section 332 is formed in the upper left portion of the guide wall 327. A first mounting part 333 is formed near the notch section 332. Four stop claw members (the first locking member) 341-344 and a first elastic member 350 which presses each of the stop claw members (the first locking member) 341-344 are formed in the first mounting part 333. The stop claw members (the first locking member) 341-344 are formed in the shape of a long thin board and form an axial part 345 in the lower end, an engaging clutch edge 346 in the upper end, and a stopping projection 347 in a lower part of the upper end. The first elastic member 350 is formed with a metal plate. Its lower part 355 is bent substantially in the shape of a letter V, and its upper part is separated into four parts, forming four elastic pieces 351-354.

As shown in FIGS. 17 and 19, the first mounting part 333 has an axis receiving part 357 substantially in the shape of a letter C and a plug concave portion 359 substantially in the shape of an angular letter U, which are located in the lower part of the notch section 332. The stop claw members (the first locking member) 341-344 are arranged so as to be layered to each other, and their axial part 345 is rotatably attached to the axis receiving part 357. The first elastic member 350 is attached to the lower part 355 substantially in the shape of a letter V being inserted into a concave portion 359. Each of the four elastic pieces 351-354 contacts with the stop claw members (the first locking member) 341-344 respectively and presses the stop claw members (the first locking member) 341-344 toward the inner side of the case 303. An engaging clutch edge 346 of the stop claw members (the first locking member) 341-344 contacts with the engaging projection 339 formed in the upper part of the notch section 332, and the stopping projection 347 projects inward from the notch section 332.

A notch section 360 is formed near the lower right end 328 of the guide wall 327. A second mounting part 361 is formed near the notch section 360. A stop claw member (the second locking member) 362 and a second elastic member 363 which presses the stop claw member (the second locking member) 362 are formed in the second mounting part 361. The stop claw member (the second locking member) 362 is formed in the shape of a long thin board and forms an axial part 365 in the lower end, an engaging clutch edge 366 in the upper end, and a stopping projection 367 in a left side of the upper end. The second elastic member 363 is formed with a metal plate. Its lower part 369 is bent substantially in the shape of a letter V.

The second mounting part 361 has an axis receiving part 370 substantially in the shape of the letter C and a plug concave portion 371 substantially in the shape of an angular letter U, which is located in the lower part of the notch section 360. An axial part 365 of the stop claw member (the second locking member) 362 is rotatably attached to the axis receiving part 370. The second elastic member 363 is attached with the lower part 369 which is substantially in the shape of a letter V and is inserted into a concave portion 371. Its upper part 368 contacts with the stop claw member (the second locking member) 362 and presses the stop claw member (the first locking member) 362 toward the inner side of the case 303. An engaging clutch edge 366 of the stop claw member (the second locking member) 362 contacts with the upper edge 372 of the notch section 360, and the stopping projection 367 projects inward from the notch section 360.

As shown in FIGS. 17 and 18, the rotating body 390 comprises a disk-shaped substrate 391 and a guide member 450 attached to the rear surface 392 (the side which does not contact with the rear surface 326 of the front wall 311) of the substrate 391 by a fixing device 479 such as a screw. An axis of rotation 394 inserted into the axis hole 320 of the case 303 is rotatably provided substantially at the center of the front surface 393 of the substrate 391. A pair of maintenance arms 395 and 396 is formed at both sides of the front surface 393 of the substrate 391, surrounding the axis of rotation 394. The maintenance arms 395 and 396 are bent and project inward, and have the center axes 397 and 398 in the lower part and stopper pins 401 and 402 in the upper part.

The center axis 397 of the maintenance arm 395 located in the right-hand side is rotatably attached to a center hole 403 formed in the lower right-hand side of the substrate 391. The maintenance arm 395 is rockably attached to the front surface 393 of the substrate 391, as a stopper pin 401 projects into a long hole 405 formed in the upper right-hand side of the substrate 391 to the rear surface 392 of the substrate 391. The maintenance arm 395 contacts with the other end 409 of a spring (elastic member) 407, one end 408 of which is attached to a spring receiving part 406 substantially in the shape of an angular letter U formed in the right-hand side of the front surface 393 of the substrate 391. The maintenance arm 395 is pressed inward by the elasticity of the spring (elastic member) 407, and the stopper pin 401 is pressed onto an inner edge 411 of the long hole 405. The position where this stopper pin 401 is pressed onto the inner edge 411 is the closed position of the maintenance arm 395 (partitioning position) P1.

The center axis 398 of the maintenance arm 396 located in the left-hand side is rotatably attached to a center hole 413 formed in the lower left-hand side of the substrate 391. The maintenance arm 396 is rockably attached to the front surface 392 of the substrate 391, as a stopper pin 402 projects in a long hole 415 formed in the upper left-hand side of the substrate 391 to the rear surface 392 of the substrate 391. The maintenance arm 396 contacts with the other end 419 of a spring (elastic member) 417, one end 418 of which is attached to a spring receiving part 416 substantially in the shape of an angular letter U formed in the left-hand side of the front surface 393 of the substrate 391. The maintenance arm 395 is pressed inward by the elasticity of the spring (elastic member) 417, and the stopper pin 402 is pressed onto an inner edge 421 of the long hole 415. The position where this stopper pin 402 is pressed onto the inner edge 421 is the closed position of the maintenance arm 396 (partitioning position) P1.

The maintenance arm 395 comprises an upper arm 434 which attaches the stopper pin 401, and a lower arm 435 which attaches the center axis 397. The upper arm 434 is connected to the lower arm 435 so that it is disposed substantially at a right angle to the spring (elastic member) 407. The maintenance arm 396 comprises an upper arm 436 which attaches the stopper pin 402, and a lower arm 437 which attaches the center axis 398. The upper arm 436 is connected to the lower arm 437 so that it is disposed substantially at a right angle to the spring (elastic member) 417. The upper arm 434 of the maintenance arm 395 and the upper arm 436 of the maintenance arm 396 are mounted so as to be substantially parallel to each other.

The distance between the stopper pin 401 and stopper pin 402 is usually narrower than the diameter of the coin C when they are closed by the elasticity of the springs (elastic members) 407 and 417. When they are open against the elasticity of the springs (elastic members) 407 and 417, the distance becomes larger than the diameter of the coin C so as to permit passage of the coin C.

The maintenance arms 395 and 396 are provided substantially symmetrically with respect to a substantially center line (perpendicular line) L of the substrate 391. A female screw portion (mounting part) 422 is formed near the upper edge of the substrate 391 and on the substantially center line L of the substrate 391. The female screw portion (mounting part) 422 is located substantially in the middle of the stopper pin 401 and the stopper pin 402. A guide projection 438 is formed on the substantially center line (vertical line) L on the rear surface 392 of the substrate 391 and under the stopper pins 401 and 402. An upper surface 439 of the guide projection 438 is sloping downwardly.

Positioning holes 425 and 426 substantially in the shape of a rectangle are formed in both right-hand and left-hand sides of a substantially middle section of the substrate 391. A coin outlet 428 substantially in the shape of a trapezoid is formed in the lower part of the substrate 391. A stopper 431 having the same thickness of the substrate 391 is formed on the periphery of the substrate 391 about 60 degrees from the substantially center line to the right. Moreover, a plurality of reverse prevention projections 432 having substantially the same thickness of the substrate 391 are formed on the periphery of the substrate 391 so as to be about 30 degrees apart from each other. The first reverse prevention projection 432 is formed about 45 degrees from substantially the center line to the left.

A guide member 450 has substantially the same periphery as the substrate 391, and comprises the coin containing section 481 which stores coin C and the coin passage 482 which is connected to the coin containing section 481. A notch section 453 which opens from the rear surface 451 to the front surface 452 is formed in the guide member 450. The notch section 453 extends vertically, has a left guide surface 455 in the upper left section, and has a right guide surface 456 in the upper right section which meets the left guide surface 455. The thickness of the left guide surface 455 and the right guide surface 456 is substantially the same as the thickness of four coins C. The coin C is guided by the left guide surface 455 and the right guide surface 456 so that it can move up and down. The coin containing section 481 which stores the coin C is formed between the left guide surface 455 and the right guide surface 456.

A concave portion 457 substantially in the shape of the letter U is formed in the left guide surface 455, with an opening facing inward. The stopper pin 402 is designed to fit in the concave portion 457. A concave portion 458 substantially in the shape of a letter U is formed in the right guide surface 456, with an inwardly facing opening. The stopper pin 401 is designed to fit in the concave portion 458.

The notch section 453 of the guide member 450 has a left curved surface 461 in the left middle part and a right curved surface 462 in the right middle part which meets the left curved surface 461. The upper end of the left curved surface 461 is connected with the lower end of the left guide surface 455. The upper end of the right curved surface 462 is connected with the lower end of the right guide surface 456. A fitting piece 463 which fits into the positioning hole 426 formed in a left-hand side of the substantially middle section of the substrate 391 is formed in the front surface 452 of the left curved surface 461. A leg piece 464 which projects into the rear surface 451 is formed in the inner end of the fitting piece 463. The leg piece 464 has substantially the same height as the left guide surface 455 and the right guide surface 456, and has a middle guide surface 465 inside.

A fitting piece 467 which fits in the positioning hole 425 formed in a right-hand side of the substantially middle section of the substrate 391 is formed in the front surface 452 of the right curved surface 462. A leg piece 469 which projects into the rear surface 451 is formed in the inner end of the fitting piece 467. The leg piece 469 has substantially the same height as the left guide surface 455 and the right guide surface 456, and has a middle guide surface 470 inside. The coin C is guided by the middle guide surface 465 of the leg piece 464 and the middle guide surface 470 of the leg piece 469 so that it can move up and down. A coin passage 482 which passes the coin C is formed between the middle guide surface 465 and the middle guide surface 470. As shown in FIG. 17, a circular axis of rotation 472 which is substantially coaxial with the guide member 450 is formed in the upper end of the leg pieces 464 and 469. A part of the back side of the axis of rotation 472 is cut out to form an engaging clutch surface 473. The engaging clutch surface 473 is planar and extends vertically.

As shown in FIG. 18, the notch section 453 of the guide member 450 has an opening 475 in the lower part formed substantially in the same shape as the coin outlet 428 formed in the lower part of the substrate 391 substantially in the shape of a trapezoid. A sloped surface 476 which guides a coin C to the coin outlet 428 is formed in the lower end of the notch section 453. The opening 475 is connected with the coin passage 482, and the coin C that fall in the coin passage 482 passes through the opening 475.

The rotating body 390 is formed by the guide member 450 being attached to the substrate 391 by a fixing device 479 such as a screw. The coin containing section 481 is formed by the left guide surface 455, the right guide surface 456, and the rear surface 392 of the substrate 391, and the coin passage 482 is formed by the middle guide surfaces 465 and 470 and the rear surface 392 of the substrate 391 in the rotating body 390. The stopper pins 401 and 402 are disposed in a closed state by the springs (elastic members) 407 and 417 between the coin containing section 481 and the coin passage 482 (closed position P1), and prevent the coin C in the coin containing section 481 from falling to the coin passage 482. A stopper piece 490 which has the stopping surface 491 is formed on the periphery of the guide member 450. The stopping surface 491 and the right guide surface 456 are formed along substantially the same surface.

As shown in FIGS. 16 and 17, an insertion hole 501 in which the axis of rotation 472 of the rotating body 390 is inserted is formed in the lid member 500. A coin slot 502 substantially in the shape of an angular letter U is formed substantially in the upper center of the lid member 500. A circular clear hole 503 is formed in the lid member 500 where it meets the coin containing section 481. An axis receiving part 507 is formed above the clear hole 503 on the rear surface 508 of the lid member 500. A pair of axis receiving pins 505 and 506 are provided in the right and left sides of the axis receiving part 507. A boss 510 having a female screw portion 511 is provided above the axis receiving part 507.

A first pressing member 515 which projects in the coin containing section 481 from the clear hole 503 is formed in the lid member 500. The first pressing member 515 comprises an arm part 516, a pivot 517 formed in the upper part of the arm part 516, a pressing projection 518 formed in the lower part of the arm part 516, and a pressed convex portion 519 provided in the upper part of the arm part 516. The pivot 517 of the first pressing member 515 is rotatably supported by the axis receiving pins 505 and 506 of the axis receiving part 507, and the pressing projection 518 projects through the clear hole 503 into the coin containing section 481. The pivot 517 of the first pressing member 515 is pressed down by the pressing member 521 in order not to move apart from the axis receiving pins 505 and 506 of the axis receiving part 507. The pressing member 521 comprises: a notch 522 substantially in the shape of an up-side down letter U, in which a pressed convex portion 519 of the first pressing member 515 is inserted; a pair of regulation projections 525 which control both sides of a spring board member 523 which presses the pressed convex portion 519 of the first pressing member 515; and a screw through hole 526 formed between the pair of the regulation projections 525. A screw through hole 527 is formed in the upper part of the spring board member 523. The spring board member 523 and the pressing member 521 are fixed to the lid member 500 by a screw 529, which is inserted into the screw through hole 527 of the spring board member 523 and then the screw through hole 526 of the pressing member 521, to the female screw portion 511 of the boss 510. The first pressing member 515 is positioned by the pressed convex portion 519 being in contact with the spring board member 523, and is maintained in the state where the pressing projection 518 projects into the coin containing section 481 from the clear hole 503.

A long hole 531 is formed to the left of the clear hole 503 in the lid member 500. A convex step portion 535, in which a concave portion 532 that attaches a spring board member 539 is formed, is provided on the rear surface 508 of the lid member 500 and below the long hole 531. The axis receiving pin 536 is provided in both sides of the upper part of the convex step portion 535, and the axis receiving part 537 is formed by the axis receiving pin 536 and the convex step portion 535. The female screw portion 533 is formed in the concave portion 532.

A second pressing member 541 which projects into the body 302 from the long hole 531 is formed on the rear surface 508 of the lid member 500. The second pressing member 541 comprises an arm part 542 and a pivot 543 formed in the lower part of the arm part 542. The pivot 543 of the second pressing member 541 is rotatably supported by the axis receiving part 537, and a tip 544 of the arm part 542 is able to project into the body 302. The pivot 543 of the second pressing member 541 is pressed down by the spring board 539 in order not to move apart from the axis receiving part 537. A screw through hole 534 is formed in the lower part of the spring board 539. The spring board 539 is fixed to the concave portion 532 by a screw 529, which is inserted into the screw through hole 534, to the female screw portion 533. The second pressing member 541 is positioned by contacting the spring board 539, and is maintained in a state where a tip 544 of the arm 542 projects into the body 302 from the long hole 531.

As shown in FIGS. 16 and 17, the positioning device 550 is formed on the rear surface 508 of the lid member 500. The positioning device 550 comprises an engaging member 551 and the third elastic member 570. The engaging member 551 has an engaging clutch board 552, an upper guide plate 553 formed in the upper end of the engaging clutch board 552, the lower guide plate 555 formed in the lower end of the engaging clutch board 552, an upper sliding board 556 formed below the upper guide plate 553, and a lower sliding board 557 formed above the lower guide plate 555. The long hole 561 extending in the horizontal direction is formed in the upper sliding board 556. The long hole 562 extending in the horizontal direction is formed in the lower sliding board 557.

The lid member 500 is provided with a top guide plate 564 which contacts with the upper guide plate 553 of the engaging member 551, a bottom guide plate 565 which contacts with the lower guide plate 555 of the engaging member 551, an engaging clutch boss 566 which engages with the long hole 561 of the upper sliding board 556, an engaging clutch boss 567 which engages with the long hole 562 of the lower sliding board 557, and a receptacle part 568 substantially in the shape of an angular letter U which receives an end of the spring-like third elastic member 570. The engaging member 551 is movable between the top guide plate 564 and the bottom guide plate 565 in the horizontal direction and is attached to the lid member 500 by a screw 569, 569 to the engaging clutch bosses 566 and 567. The spring-like third elastic member 570 between the engaging clutch board 552 and the receptacle part 568 presses the engaging clutch board 552 in the engaging direction into the engaging clutch surface 473 of the axis of rotation 472, and positions the axis of rotation 472, the rotating body 390, and the axis of rotation 394.

A coin outlet 571 which connects the front surface 509 and the rear surface 508 is formed in the lower left part of the lid member 500. A guide piece 572 which guides the coin C to the coin outlet 571 is formed in the lower left of the rear surface 326 of the case 303. A ring member (changing member) 580 which has the thickness of two coins C is attached to the upper right part of the rear surface 508 of the lid member 500 by the screw 581. This ring member (changing member) 580 can be attached to the female screw portion (mounting part) 422 of the rotating body 390 by the screw 581. The fitting arms 582 and 583 are formed in both sides of the lid member 500.

The axis of rotation 394 of the rotating body 390 is received rotatably by the axis hole 320 of the case 303, and the tip part 399 protrudes from the axis hole 320. As shown in FIG. 18, a handle 600 is fixed to the tip part 399 of the axis of rotation 394. A mounting hole 375 is formed in the tip part 399 of the axis of rotation 394. A fixed axis 601 is formed substantially in the center of the handle 600, is not rotatable in the mounting hole 375 of the axis of rotation 394, and is fixed to the axis of rotation 394 by a screw, etc.

The rotating body 390 is stored in the body 302, the axis of rotation 394 is rotatably received by the axis hole 320 of the case 303, and the axis of rotation 472 is rotatably received by the insertion hole 501 of the lid member 500.

The engaging clutch board 552 of the engaging member 551 is pressed onto the engaging clutch surface 473 formed in the axis of rotation 472 by the third elastic member 570. The rotating body 390 is thus positioned. That is, the rotating body 390 is positioned by the positioning device 550 in the position (initial position) where the opening 441 of the coin containing section 481 and the coin slot 502 of the body 302 meet and the coin C inserted from the coin slot 502 is stored directly in the coin containing section 481, and is standing by at this position.

The pressing projection 518 of the first pressing member 515 projects through the clear hole 503 into the coin containing section 481. The tip 544 of the arm part 542 of the second pressing member 541 projects through the long hole 531 into the body 302 and presses the rear surface of the rotating body 390, i.e., the rear surface of the guide member 450.

As shown in FIG. 19, if the rotating body 390 is rotated from the initial position in one direction (X direction; counterclockwise) by operation of the handle 600 when a coin C is not stored in the coin containing section 481, the rotating body 390 cannot be rotated further, since the engaging clutch edge 347 of the stop claw members (the first locking members) 341-344 stops the stopping surface 491 of the stopper piece 490.

Also in the above situation, the rotating body 390 cannot be rotated further, since the tip 544 of the second pressing member 541 pressed by the rear surface 451 of the guide member 450 projects into the coin containing section 481 and stops the right guide surface 456 of the guide member 450 by the elasticity of the spring board 539.

If the rotating body 390 is rotated from the initial position in one direction (X direction; counterclockwise) when four fake coins which have the same thickness as the real coin C but have a smaller diameter than the real coin C are stored in the coin containing section 481 from the coin slot 502, rotation of the rotating body 390 is not prevented, since the tip 544 of the second pressing member 541 does not project into the coin containing section 481 and does not stop the right guide surface 456 of the guide member 450.

However, since the diameter of the fake coins is smaller than that of the real coin C, the fake coins cannot move the stop claw members (the first locking members) 341-344 opposite to the stopping direction against the elasticity of the first elastic member 350. Thus, the rotating body 390 cannot be rotated further after all, since the engaging clutch edge 347 of the stop claw members (the first locking members) 341-344 stops the stopping surface 491 of the stopper piece 490. Even if only one coin is false and three others are real coins, one of the stop claw members (the first locking member) 341-344 located where the fake coin is can prevent rotation.

When four fake coins which have the same diameter as the real coin C but are thinner than the real coin C are stored in the coin containing section 481 from the coin slot 502, rotation of the rotating body 390 is prevented, since these four fake coins cannot prevent the tip 544 of the second pressing member 541 from projecting into the coin containing section 481 and stop the right guide surface 456 of the guide member 450.

As shown in FIG. 20, when four real coins C are inserted from the coin slot 502, the coins are stored in the coin containing section 481 as they sit on the stopper pins 401 and 402. That is, the coins C inserted from the coin slot 502 are held in the coin containing section 481 since they are prevented from moving to the coin passage 482 by the stopper pins 401 and 402 which are at the closed position P1. The four real coins in the coin containing section 481 are pressed by the pressing projection 518 of the first pressing member 515 and are positioned within the coin containing section 481.

As shown in FIG. 21, if the rotating body 390 is rotated in one direction (X direction; counterclockwise) by operation of the handle 600, the engaging clutch edge 347 of the stop claw members (the first locking members) 341-344 does not stop the stopping surface 491 of the stopper piece 490, and rotation of the rotating body 390 is not prevented, since the four real coins C contact the stopping projection 347 of the stop claw members (the first locking members) 341-344 and move the stop claw members (the first locking member) 341-344 opposite to the stopping direction against the elasticity of the first elastic member 350. Also, since the tip 544 of the second pressing member 541 does not project into the coin containing section 481 by these four real coins C, it does not stop the right guide surface 456 of the guide member 450 and does not prevent rotation of the rotating body 390.

As shown in FIG. 22, if the rotating body 390 is rotated about 120 degrees in one direction (X direction; counterclockwise), the opening 441 of the coin containing section 481 of the rotating body 390 faces downward. The four real coins C then fall to the coin outlet 571 from the opening 441 via the guide piece 572 due to their own weight and are discharged from the coin outlet 571.

As shown in FIG. 20, if four real coins C are inserted from the coin slot 502, the coins are stored in the coin containing section 481 as they sit on the stopper pins 401 and 402. However, if a coin with a small diameter is inserted, the coin moves to the coin passage 482 through an opening between the stopper pins 401 and 402 in the closed position P1, falls to the opening 475, and is returned in the coin return concave portion 323 of the coin return part 322 from the coin outlet 428 through the coin-return opening 325 of the body 302, guided by a sloped surface 476. That is, a coin with a smaller diameter than the real coin C is not stored in the coin containing section 481 and is returned in the coin return part 322.

The stopper piece 490 of the rotating body 390 contacts with the stopping projection 347 of the stop claw members (the first locking member) 341-344 and the stopping projection 367 of the stop claw member (the second locking member) 362. The reverse prevention projection 432 and the stopper 431 of the rotating body 390 do not contact with the stopping projection 347 of the stop claw members (the first locking members) 341-344, but contact the stopping projection 367 of the stop claw member (the second locking member) 362.

If the rotating body 390 is rotated in one direction (X direction; counterclockwise), the stopping surface 491 of the stopper piece 490 contacts the stopping projection 347 of the stop claw members (the first locking members) 341-344 to prevent further rotation. However, the stopper piece 490 moves the stop claw member (the second locking member) 362 opposite to the stopping direction against the elasticity of the second elastic member 363, the stopping surface 491 is not stopped by the stopping projection 367 of the stop claw member (the second locking member) 362, and the rotation of the rotating body 390 in one direction (X direction; counterclockwise) is not prevented.

If the rotating body 390 is rotated in one direction (X direction; counterclockwise), since the reverse prevention projections 432 of the rotating body 390 contact the stopping projection 367 of the stop claw member (the second locking member) 362 one by one and move the stop claw member (the second locking member) 362 opposite to the stopping direction against the elasticity of the second elastic member 363, the reverse prevention projections 432 are not stopped by the stopping projection 367 of the stop claw member (the second locking member) 362, and the rotation of the rotating body 390 in one direction (X direction; counterclockwise) is not prevented.

If the rotating body 390 is rotated in one direction (X direction; counterclockwise), since the stopper 431, as the reverse prevention projections 432, contacts the stopping projection 367 of the stop claw member (the second locking member) 362 and moves the stop claw member (the second locking member) 362 opposite to the stopping direction against the elasticity of the second elastic member 363, the stopper 431 is not stopped by the stopping projection 367 of the stop claw member (the second locking member) 362, and the rotation of the rotating body 390 in one direction (X direction; counterclockwise) is not prevented.

When the rotating body 390 is rotated in one direction (X direction; counterclockwise), if the reverse prevention projection 432 and the stopper 431 of the rotating body 390 pass the stopping projection 367 of the stop claw member (the second locking member) 362, rotation of the rotating body 390 in the other direction (Y direction; clockwise) is prevented, since they are stopped by the stopping projection 367 of the stop claw member (the second locking member) 362.

As shown in FIG. 20, if the rotating body 390 has been rotated about 360 degrees in one direction (X direction; counterclockwise), the rotating body 390 is positioned where the opening 441 of the coin containing section 481 meets the coin slot 502, and the coin C inserted from the coin slot 502 is stored directly in the coin containing section 481 (initial position) by the positioning device 550.

Next, the number of the real coins C to be inserted will be changed. The screw 581 is unscrewed, and the ring member (changing member) 580 is taken off from the body 302 shown in FIG. 16. As shown in FIG. 18, the ring member (changing member) 580 is attached to the female screw portion (mounting part) 422 formed on the substrate 391 by the screw 581. As shown in FIG. 20, the ring member (changing member) 580 projects over a periphery of the substrate 391, and the projection end 585 substantially coincides with a periphery of the real coin C stored in the coin storing section 481. The ring member (changing member) 580 has the same thickness as two real coins C as stated above.

When two real coins C are inserted from the coin slot 502, the two real coins C are stored in the coin containing section 481. The two real coins C sit on the stopper pins 401 and 402 and are stored in the coin containing section 481 since they are prevented from moving to the coin passage 482.

At this time, the two real coins C are pressed by the pressing projection 518 of the first pressing member 515 and positioned within the coin containing section 481. As shown in FIG. 21, if the handle 600 is operated and the rotating body 390 is rotated in one direction (X direction; counterclockwise), the two real coins C contact the stopping projection 347 of the stop claw members (the first locking member) 341 and 342, and the ring member (changing member) 580 contacts the stopping projection 347 of the stop claw members (the first locking member) 343 and 344. Thus, since the stop claw members (the first locking members) 341-344 move opposite to the stopping direction against the elasticity of the first elastic member 350, the engaging clutch edge 347 of the stop claw members (the first locking member) 341-344 does not stop the stopping surface 491 of the stopper piece 490, and rotation of the rotating body 390 is not prevented. The rotating body 390 is rotated the rest of the way in a similar way to when four coins are stored.

Next, return of the coin C is explained below. If a coin C is inserted from the coin slot 502, the coin C is stored in the coin containing section 481. The coin C sits on the stopper pins 401 and 402 at the closed position (partitioning position) P1. That is, when the rotating body 390 is at the initial position where the coin slot 502 and the opening 441 of the body 302 meet, the coin C inserted from the coin slot 502 is prevented from moving to the coin passage 482 by the stopper pins 401 and 402 and is stored in the coin containing section 481. In this case, the coin C inserted does not have to be a real coin, and the number of coins does not have to be correct either.

As shown in FIG. 23, if the handle 600 is operated and the rotating body 390 is rotated 30 degrees in the other direction (Y direction; clockwise), the right maintenance arm 395 engages with the right engaging member 331 of the guide 330 and is moved in the clockwise direction against the elasticity of the spring (elastic member) 407 centering around the center axis 397 to the open position (non-partitioning position) P2. Likewise, the left maintenance arm 396 engages with the left engaging member 331 of the guide 330 and is moved in the counterclockwise direction against the elasticity of the spring (elastic member) 417 centering around the center axis 398 to the open position (non-partitioning position) P2.

When the right maintenance arm 395 is rotated in the clockwise direction and the left maintenance arm 396 is rotated in the counterclockwise direction to the open position (non-partitioning position) P2, the gap between the stopper pins 401 and 402 becomes wider, and the coin C moves away from the stopper pins 401 and 402 and moves to the coin passage 482 passing through the opening between the stopper pins 401 and 402 due to its own weight. The coin C further falls to the opening 475 and is returned in the coin return concave portion 323 of the coin return section 322 from the coin outlet 428 through the coin return opening 325, guided by the sloped surface 476.

When four coins C are stored in the coin containing section 481, first two coins in the back fall into the coin passage 482 by the guide projection 438. Then, the rest of the coins slide down to the coin passage 482 one by one on the tilted upper surface 439 of the guide projection 438. Thus, the coin passage 482 is not clogged by coins because four coins do not fall simultaneously.

When the rotating body 390 is rotated 30 degrees in the other direction (Y direction; clockwise) by operation of the handle 600, the stopping surface (second engaging clutch edge) 430 of the stopper pin 431 is stopped by the stopping projection 367 of the stop claw member (second locking member) 362, so further rotation of the rotating body 390 in the other direction (Y direction; clockwise) is prevented.

In short, after the rotating body 390 is rotated from the initial position in the other direction (Y direction; clockwise) and the coin C in the coin containing section 481 is dropped to the coin passage 482, the stop claw member (the second locking member) 362 stops the second stopping edge 430 of the stopper 431 of the rotating body 390, and further rotation of the rotating body 390 in the other direction (Y direction; clockwise) is prevented.

As shown in FIG. 20, if the rotating body 390 is rotated in one direction (X direction; counterclockwise) to return to the initial position, the rotating body 390 is positioned where the coin containing section 481 is substantially straight up, and the coin C inserted from the coin slot 502 is stored directly in the coin containing section 481 by the positioning device 550.

### EFFECT OF THE INVENTION

In the coin identifying device according to the present invention, when incorrect number of real coins C are inserted from a coin slot, rotation of a rotating body is prevented because a stopping edge of the rotating body is stopped by one of the locking members. Also, when a plurality of coins including a fake coin with a smaller diameter than a real coin is inserted from the coin slot and stored in the coin containing section of the rotating body, rotation of the rotating body is prevented because the periphery of the fake coin cannot move one of the locking members, and the stopping edge of the rotating body is stopped by a locking member where the fake coin is located. When the correct number of real coins are inserted from the coin slot and the plurality of coins are stored in the coin containing section of the rotating body, rotation of the rotating body is possible because the plurality of the locking members move opposite to the stopping direction by contacting the periphery of each real coin at the time of rotation of the rotating body and do not stop the stopping edge of the rotating body. Thus, the plurality of coins in the coin containing section can be discharged from a coin outlet.

A switching member which changes the number of coins stored in the coin containing section is rotatably provided in the rotating body. The coin containing section comprises the first coin containing section formed in the rotating body and the second coin containing section formed in the switching member. If the switching member is rotated in one direction against the rotating body, the second coin containing section overlaps with the first coin containing section of the rotating body so that the coin containing section comprises the second coin containing section and the first coin containing section. If the switching member is rotated in the other direction, the second coin containing section separates from the first coin containing section of the rotating body so that the coin containing section only comprises the first coin containing section. Thus, the number of coins stored in the coin containing section can be changed. Thus, in the coin identifying device according to the present invention, the number of coins inserted can be changed easily by the switching member.

In the coin identifying device according to the present invention, when the second coin containing section of the switching member separates from the first coin containing section of the rotating body so that the coin containing section only comprises the first coin containing section, the guiding edge of the switching member moves the locking member opposite to the stopping direction by contacting the locking member at the time of rotation of the rotating body and can prevent the locking member from stopping the stopping edge.

In the coin identifying device according to the present invention, when an incorrect number of real coins or a fake coin with different thickness than a real coin is stored in the coin containing section, an engaging clutch piece is engaged with one side of the body to prevent rotation of the rotating body. When the correct number of real coins are stored in the coin containing section, the coins move the engaging clutch piece opposite to the engaging direction, and the engaging clutch piece does not engage with one side of the body, so that rotation of the rotating body is not prevented. Thus, the coin identifying device according to the present invention can also detect the thicknesses of the coins.

When the switching member is rotated in one direction against the rotating body and the second coin containing section overlaps with the first coin containing section of the rotating body so that the coin containing section comprises the second coin containing section and the first coin containing section, an engaging convex portion or an engaging recess engages with a first engaging recess or a first engaging convex portion so as to position the switching member. If the switching member is rotated in the other direction and the second coin containing section of the switching member separates from the first coin containing section of the rotating body so that the coin containing section only comprises the first coin containing section, the engaging convex portion or the engaging recess engages with a second engaging recess or a second engaging convex portion so as to position the switching member. Thus, the coin identifying device according to the present invention can securely maintain the positions switched by the switching member.

Also in the coin identifying device according to the present invention, a mounting part which attaches the changing member by which the number of coins stored is changed is formed in the coin containing section of the rotating body. The changing member is attached in one side of the body so as to be detachable. The number of coins stored in the coin containing section can be changed by removing the changing member from the body and attaching it to the mounting part of the coin containing section. Thus, the coin identifying device according to the present invention can change the number of coins stored easily by the changing member.

In the coin identifying device according to the present invention, a coin inserted from the coin slot is stored in the coin containing section of the rotating body which is in the initial position. If a coin is stored in the coin containing section of the rotating body, the coin is prevented from falling to the coin passage by a partition member which partitions the coin containing section and the coin passage and is kept in the coin containing section. When a real coin is not inserted from the coin slot or when a fake coin with smaller diameter than a real coin is inserted from the coin slot, the first stopping edge of the rotating body is stopped by the first locking member, and rotation of the rotating body in one direction from the initial position is prevented. When a real coin is inserted from the coin slot and stored in the coin containing section of the rotating body, the first locking member moves opposite to the stopping direction by contacting a periphery of the real coin and does not stop the first stopping edge of the rotating body at the time of rotation of the rotating body in one direction. Thus, rotation of the rotating body in one direction is possible, and the coin in the coin containing section can be discharged from the coin outlet guided by the partition member. If the handle is operated and the rotating body is rotated in the other direction from the initial position when a coin is stored in the coin containing section of the rotating body, the coin moves away from the partition member, falls to the coin passage, and is returned from a coin-return opening.

Also in the coin identifying device according to the present invention, a coin inserted from the coin slot is stored in the coin containing section of the rotating body which is in the initial position. If a coin is stored in the coin containing section of the rotating body, the coin is prevented from falling to the coin passage by the partition member which is pressed by a fourth elastic member at the partitioning position and which partitions the coin containing section and the coin passage, and the coin is kept in the coin containing section. When a real coin is inserted from the coin slot and the rotating body is rotated from the initial position in one direction by operation of the handle, the first locking member moves opposite to the stopping direction by contacting a periphery of the real coin, and the coin in the coin containing section can be discharged from the coin outlet. If the rotating body is rotated in the other direction from the initial position by operation of the handle when a coin is stored in the coin containing section of the rotating body, the partition member at the partitioning position engages with the engaging member and moves to the non-partitioning position against the fourth elastic member. Thus, the coin moves away from the partition member, falls to the coin passage, and is returned from the coin-return opening.

Further in the coin identifying device according to the present invention, a coin inserted from the coin slot is stored in the coin containing section of the rotating body which is in the initial position. If a coin is stored in the coin containing section of the rotating body, the coin is prevented from falling to the coin passage by a pair of coin stoppers which are pressed by the fourth elastic member to a closed position and are located between the coin containing section and the coin passage, and the coin is kept in the coin containing section. When a real coin is inserted from the coin slot and the rotating body is rotated from the initial position in one direction by operation of the handle, the first locking member moves opposite to the stopping direction by contacting a periphery of the real coin, and the coin in the coin containing section can be discharged from the coin outlet. If the rotating body is rotated in the other direction from the initial position by operation of the handle when a coin is stored in the coin containing section of the rotating body, the pair of the coin stoppers at the closed position engages with the engaging member and moves to the open position against the fourth elastic member. Thus, the coin moves away from the pair of the coin stoppers, falls to the coin passage, and is returned from the coin-return opening.

Therefore, with the coin identifying device according to the present invention, if the rotating body is rotated in one direction, an article can be extracted, and if the rotating body is rotated in the other direction, a coin can be returned. Thus, the coin identifying device according to the present invention does not require complicated mechanisms such as a return button and can be manufactured inexpensively.

Since the second locking member stops the second stopping edge of the rotating body and prevents the rotation of the rotating body in the other direction after the rotating body is rotated from the initial position in the other direction and the coin in the coin containing section falls to the coin passage, the coin identifying device according to the present invention can prevent excess reverse rotation.

Since a positioning device can position the rotating body at the initial position, in the coin identifying device according to the present invention, the rotating body can stand by in the initial position without needlessly rotating.

### EXPLANATION OF REFERENCE NUMERALS

C: coin, P1: closed position (partition position), P2: opened position (non-partition position), 1: coin identifying device, 2: body, 3: case, 3a: rear releasing part, 3b: lower releasing part, 5: fixing device, 6: one side, 11: front wall, 12: top wall, 13: left wall, 14: right wall, 15: interior, 16: concave portion, 17: base, 19: side, 20: axis hole, 22: concave gap, 25: first guide wall, 26: second guide wall, 27: lower right end, 28: left end, 29: storage room, 30: top end, 31: lower end, 33: notch, 35: coin slot, 36: coin outlet, 38: notch section, 39: engaging projection, 40: upper concave portion, 41: stop claw member (first locking member), 42: stop claw member (first locking member), 43: stop claw member (first locking member), 44: stop claw member (first locking member), 45: axial part, 46: engaging clutch edge, 47: stopping projection, 50: first elastic member, 51: elastic piece, 52: elastic piece, 53: elastic piece, 54: elastic piece, 55: lower part, 57: axis receiving part, 59: plug slot, 60: notch section, 61: lower concave portion, 62: stop claw member (second locking member), 63: second elastic member, 65: axial part, 66: engaging clutch edge, 67: stopping projection, 68: upper part, 69: lower part, 70: axis receiving part, 71: plug slot, 72: engaging projection, 75: first guide groove, 76: second guide groove, 79: pin, 81: first outlet (coin outlet), 82: second outlet (coin-return opening), 85: opening:, 90: rotating body, 91: substrate, 91a: surface, 91b: back, 92: right guide member, 93: left guide member, 94: axis of rotation, 95: protruded piece, 96: groove, 97: top end, 98: tip part, 99: notch, 100: engaging clutch piece, 101: axis, 102: axis receiving concave portion, 103: fixed board, 104: back, 105: guide cylinder, 106: guide shaft, 107: elastic member, 109: top end, 110: upper right portion guide surface, 111: right curved surface, 112: lower right portion guide surface, 113: right outer perimeter surface, 115: stopper piece, 116: first stopping edge, 117: second stopping edge, 120: upper left portion guide surface, 121: left curved surface, 122: lower left portion guide surface, 123: left outer perimeter surface, 125: notch, 126: engaging clutch piece, 127: bendable piece, 128: engaging clutch convex portion, 130: engaging step portion, 131: upper part, 132: lower part, 133: opening, 135: coin containing section, 136: one end (upper end), 137: other end (lower end), 138: one end (upper end), 139: other end (lower end), 140: first coin containing section, 141: first coin passage, 142: second coin passage, 143: coin passage, 145: center axis, 146: mounting plate, 147: mounting piece, 147a bottom wall, 147b side wall, 148: guide piece, 149: fixing device, 150: switching member, 151: guide ring, 152: outer perimeter surface, 153: back, 154: second coin containing section, 155: right guide member, 156: upper right portion guide surface, 157: right curved surface, 158: lower right portion guide surface, 159: right outer perimeter surface, 160: left guide member, 161: upper left portion guide surface, 162: left curved surface, 163: lower left portion guide surface, 165: left outer perimeter surface, 166: first engaging recess, 167: second engaging recess, 168: guide edge, 169: outer diameter, 170: lid member, 171: concave portion, 172: side, 173: insertion hole, 175: partition member, 180: notch, 181: long hole, 182: right axis receiving projection, 183: left axis receiving projection, 185: right axis receiving concave portion, 186: left axis receiving concave portion, 187: spring receiving piece, 190: pressing member, 191: rocking member, 192: first press piece member, 193: second press piece member, 195: rocking board, 196: rocking axis, 197: clear hole, 201: pivot, 202: pivot, 203: axis receiving board, 205: axis receiving part, 206: axis receiving part, 210: axis receiving piece, 211: pressing piece, 212: axis receiving part, 213: axis receiving part, 214: spring member, 215: tip, 216: pressing piece, 217: pivot, 218: tip, 219: elastic piece, 220: one part, 221: screw, 222: lock piece, 225: axis of rotation, 226: screw, 228: engaged member, 230: engaged part, 231: engaging member, 232: upper part, 233: screw, 235: engaging clutch edge, 236: lower part, 237: hook, 240: positioning device, 241: third elastic member, 242: one end, 243: other end, 245: screw, 250: handle, 251: fixed axis, 252: mounting hole, 253: screw, 301: coin identifying device, 302: body, 303: case, 304: rear releasing part, 305: fixing device, 311: front wall, 312: top wall, 313: left wall, 314: right wall, 315: front, 316: projection band, 317: concave portion, 318: bottom wall, 320: axis hole, 321: concave portion, 322: coin-return part, 323: coin-return concave portion, 325: coin-return opening, 326: rear surface, 327: guide wall, 328: right end, 329: left end, 330: guide, 331: engaging member, 332: notch section, 333: first fitting part, 335: guide member, 336: fixing device, 339: engaging projection, 341: stop claw member (first locking member), 342: stop claw member (first locking member), 343: stop claw member (first locking member), 344: stop claw member (first locking member), 345: axial part, 346: engaging clutch edge, 347: engaging projection, 350: first elastic member, 351: elastic piece, 352: elastic piece, 353: elastic piece, 354: elastic piece, 355: lower part, 357: axis receiving part, 359: plug concave portion, 360: notch section, 361: second fitting part, 362: stop claw member (second locking member), 363: second elastic member, 365: axial part, 366: engaging clutch edge, 367: engaging projection, 368: upper part, 369: lower part, 370: axis receiving part, 371: plug concave portion, 372: upper edge, 375: mounting hole, 390: rotating body, 391: substrate, 392: rear surface, 393: front, 394: axis of rotation, 395: maintenance arm (partition member, coin stopper), 396: maintenance arm (partition member, coin stopper), 397: center axis, 398: center axis, 399: tip part, 401: stopper pin, 402: stopper pin, 403: center hole, 405: long hole, 406: spring receiving part, 407: spring (fourth elastic member), 408: one end, 409: other end, 411: inner edge, 413: center hole, 415: long hole, 416: spring receiving part, 417: spring (fourth elastic member), 418: one end, 419: other end, 421: inner edge, 422: female screw portion (fitting part), 425: positioning hole, 426: positioning hole, 428: coin outlet, 430: stopping surface (second stopping edge), 431: stopper, 432: reverse prevention projection, 434: upper arm, 435: upper arm, 436: upper arm, 437: upper arm, 438: guide projection, 439: upper surface, 441: opening, 442: one end, 443: other end, 445: one end, 446: other end, 450: guide member, 451: rear surface, 452: front, 453: notch section, 455: left guide surface, 456: right guide surface, 457: concave portion, 458: concave portion, 461: left curved surface, 462: right curved surface, 463: fitting piece, 464: leg piece, 465: middle guide surface, 467: fitting piece, 469: leg piece, 470: middle guide surface, 472: axis of rotation, 473: engaging clutch surface (engaged part), 475: opening, 476: sloped surface, 479: engaging clutch surface, 481: coin containing section, 482: coin passage, 490: stopper piece, 491: stopping surface (first stopping edge), 500: lid member, 501: insertion hole, 502: coin slot, 503: clear hole, 505: axis receiving pin, 506: axis receiving pin, 507: axis receiving part, 508: rear surface, 509: front, 510: boss, 511: female screw portion, 515: first pressing member, 516: arm part, 517: pivot, 518: pressing projection, 519: pressed convex portion, 521: pressing member, 522: notch, 523: spring board member, 525: regulation projection, 526: screw through hole, 527: screw through hole, 529: screw, 531: long hole, 532: concave portion, 533: female screw portion, 534: screw through hole, 535: convex step portion, 536: axis receiving pin, 537: axis receiving part, 539: spring board, 541: second pressing member, 542: arm part, 543: pivot, 544: tip, 550: positioning device, 551: engaging member, 552: engaging clutch board, 553: top guide plate, 555: bottom guide plate, 556: top sliding board, 557: bottom sliding board, 561: long hole, 562: long hole, 564: top guide plate, 565: bottom guide plate, 566: engaging clutch boss, 567: engaging clutch boss, 568: receptacle part, 569: screw, 570: third elastic member, 571: coin outlet, 572: guide piece, 580: ring member (changing member), 581: screw, 582: fitting arm, 583: fitting

### INDUSTRIAL APPLICABILITY

The present invention relates to the coin identifying device where a handle can be operated when a real coin is inserted, and where a handle cannot be operated when a fake coin is inserted or no coin is inserted. The present invention can be applied to an article dispensing machine, such as a capsule machine.

1: A coin identifying device comprising:
a body including a coin slot in an upper part, a coin outlet in a lower part, and a rotating body which is operated by a handle and which is rotatably provided inside said body;
said rotating body including at least one portion forming a coin containing section, whereby the coin containing section can store a plurality of coins in a stack which are inserted from said coin slot;
said body including a plurality of locking members, each of said plurality of locking members being contacted by a respective elastic member and can stop and prevent rotation of said rotating body by contact with a stopping edge of said rotating body at the time of rotation of said rotating body; said plurality of locking members being capable of moving against a respective elastic member by contact with a periphery of a correct number of real coins, whereby the correct number of real coins are discharged from said coin outlet after said stopping edge passes said plurality of locking members; and
a switching member being rotatably provided adjacent to said rotating body for changing a size of the coin containing section;
and said switching member being disposed in a first position to form a first coin containing section having a first size and is disposed in a second position to form a second coin containing section having a second size.

2. The coin identifying device according to claim 1, further comprising a guide edge disposed in said switching member, whereby said guide edge is capable of pushing up said locking member by contact with said locking member to allow rotation of said rotating body.

3. The coin identifying device according to claim 1, wherein
an engaging clutch piece is disposed adjacent to said rotating body; and
said engaging clutch piece is movable between a first position for allowing rotation of said rotating body and a second position for stopping rotation of said rotating body.

4. The coin identifying device according to claim 1, wherein
at least one of said rotating body and said switching member has at least one of an engaging clutch convex portion and an engaging recess; and
said switching member is movable between two positions.

5. A coin identifying device comprising
a body including a coin slot in an upper part, a coin outlet in a lower part, and a rotating body which is operated by a handle and which is rotatably provided inside said body;
said rotating body including at least one portion forming a coin containing section, whereby the coin containing section can store a plurality of coins in a stack which are inserted from said coin slot;
said body has a plurality of locking members, each of said plurality of locking members being contacted by a respective elastic member and can stop and prevent rotation of said rotating body by contact with a stopping edge of said rotating body at the time of rotation of said rotating body; said plurality of locking members being capable of moving against a respective elastic member by contact with a periphery of a correct number of real coins, whereby the correct number of real coins are discharged from said coin outlet after said stopping edge passes said plurality of locking members;
a mounting part for mounting a changing member capable of changing the number of coins stored being disposed adjacent to the coin containing section of said rotating body; and
said changing member being removably provided on one side of said body.

6. A coin identifying device comprising:
a body including a coin slot in an upper part, a coin outlet and a coin-return opening in a lower part, and a rotating body which is operated by a handle and which is rotatably provided inside said body;
said rotating body including at least one portion forming a coin containing section and standing by at an initial position where coins inserted from said coin slot are stored in the coin containing section;
said body including a first locking member;
said first locking member can stop and prevent rotation of said rotating body by contact with a first stopping edge of said rotating body at the time of rotation of said rotating body in one direction from the initial position; and said first locking member being capable of moving against a first elastic member by contact with a periphery of a real coin, whereby the real coin is discharged from said coin outlet after said first stopping edge passes said first locking member;
said rotating body including at least one portion forming a coin passage, whereby the coin passage is connected with the coin containing section and a coin falls to said coin-return opening in the coin passage; and
said body including a partition member, whereby said partition member is movable between a first position for partitioning the coin containing section and the coin passage and preventing the coin in the coin containing section from falling to the coin passage and a second position for not partitioning the coin containing section and the coin passage and allowing the coin in the coin containing section to fall to the coin passage and to be discharged from said coin-return opening.

7. A coin identifying device comprising:
a body including a coin slot in an upper part, a coin outlet and a coin-return opening in a lower part, and a rotating body which is operated by a handle and which is rotatably provided inside said body;
said rotating body including at least one portion forming a coin containing section and standing by at an initial position where coins inserted from said coin slot are stored in the coin containing section;
said body including a first locking member;
said first locking member can stop and prevent rotation of said rotating body by contact with a first stopping edge of said rotating body at the time of rotation of said rotating body in one direction from the initial position; and said first locking member being capable of moving against a first elastic member by contact with a periphery of a real coin, whereby the real coin is discharged from said coin outlet after said first stopping edge passes said first locking member;
said rotating body including at least one portion forming a coin passage, whereby the coin passage is connected with the coin containing section and in which a coin falls to said coin-return opening in the coin passage, and further including a partition member which partitions the coin containing section and the coin passage;
said partition member is movable between a partition position for preventing a coin from falling and a non-partition position for allowing a coin to fall, and is contacted by an elastic member; and
said body including an engaging member, whereby said engaging member does not engage with said partition member and prevents the coin in the coin containing section from falling to the coin passage at the time of rotation of said rotating body from the initial position in one direction, and engages with said partition member and moves said partition member to the non-partition position to allow the coin in the coin containing section to fall to the coin passage and to be discharged from said coin-return opening at the time of rotation of said rotating body from the initial position in another direction.

8. A coin identifying device comprising:
a body including a coin slot in an upper part, a coin outlet and a coin-return opening in a lower part, and a rotating body which is operated by a handle and which is rotatably provided inside said body;
said rotating body including at least one portion forming a coin containing section and standing by at an initial position where coins inserted from said coin slot are stored in the coin containing section;
said body including a first locking member;
said first locking member can stop and prevent rotation of said rotating body by contact with a first stopping edge of said rotating body at the time of rotation of said rotating body in one direction from the initial position; and said first locking member being capable of moving against a first elastic member by contact with a periphery of a real coin, whereby the real coin is discharged from said coin outlet after said first stopping edge passes said first locking member;
said rotating body including at least one portion forming a coin passage, whereby the coin passage is connected with said the coin containing section and a coin falls to said coin-return opening in the coin passage, and further including a pair of coin stoppers between the coin containing section and the coin passage;
said pair of coin stoppers is movable between a closed position for preventing a coin from falling and an open position for allowing a coin to fall, and is contacted by an elastic member; and
said body including an engaging member, whereby said engaging member does not engage with said pair of coin stoppers and prevents the coin in the coin containing section from falling to the coin passage at the time of rotation of said rotating body from the initial position in one direction, and engages with said pair of coin stoppers and moves said pair of coin stoppers to the open position to allow the coin in the coin containing section to fall to the coin passage and to be discharged from said coin-return opening at the time of rotation of said rotating body from the initial position in another direction.

9. The coin identifying device according to claim 6, further comprising a second locking member disposed in said body and contacted by a second elastic member, whereby said second locking member stops and prevents rotation of said rotating body in the other direction by contact with a second stopping edge of said rotating body, after said rotating body is rotated from the initial position in another direction and the coin in the coin containing section falls to the coin passage.

10. The coin identifying device according to claim 9, further comprising a positioning device disposed in said body and capable of positioning said rotating body at the initial position, whereby said positioning device comprises an engaging member which engages with an engaged part disposed in said rotating body, and a third elastic member which contacts with said engaging member.

11. A coin identifying device comprising:
a body including a coin slot formed in an upper part, and a coin outlet and a coin-return opening formed in a lower part;
a rotating body rotatably provided inside said body;
a partition member which is provided in said body and which projects into said rotating body;
an opening provided at a periphery of said rotating body;
a coin containing section formed in said rotating body, whereby one end of the coin containing section is disposed adjacent to said opening, and another end of the coin containing section is movable between a position facing said partition member and a position not facing said partition member; and
a coin passage formed in said rotating body, whereby the coin passage is disposed adjacent to one end of the coin containing section at one end and is disposed adjacent to an exterior of said rotating body at another end;
wherein
when said rotating body is at an initial position where said coin slot of said body and said opening meet and when said rotating body is rotated from the initial position in one direction, a coin inserted from said coin slot is prevented from moving to the coin passage and is held in the coin containing section;
when said rotating body is rotated over 90 degrees from the initial position in one direction, the coin held in the coin containing section is discharged from said coin outlet via said opening; and
when said rotating body is rotated from the initial position in another direction, the coin held in the coin containing section is enabled to move to the coin passage, and is discharged from said coin-return opening via the coin passage.

12. A coin identifying device comprising:
a body including a coin slot formed in an upper part, and a coin outlet and a coin-return opening formed in a lower part;
a rotating body rotatably provided inside said body;
an opening provided at a periphery of said rotating body;
a coin containing section which is provided in said rotating body, whereby the coin containing section is disposed adjacent to said opening at one end;
a coin passage formed in said rotating body, whereby the coin passage is disposed adjacent to one end of the coin containing section at one end, and is disposed adjacent to an exterior of said rotating body at another end;
a partition member which is provided in said rotating body, which partitions the coin containing section and the coin passage, which is movable between a partition position for preventing a coin from falling and a non-partition position for allowing a coin to fall, and which is contacted by an elastic member; and
an engaging member which is provided in said body, whereby said engaging member does not engage with said partition member and prevents the coin in the coin containing section from falling to the coin passage at the time of rotation of said rotating body from the initial position in one direction, and engages with said partition member and moves said partition member to the non-partition position to allow the coin in the coin containing section to fall to the coin passage and to be discharged from said coin-return opening at the time of rotation of said rotating body from the initial position in another direction;
wherein
when said rotating body is at the initial position where said coin slot of said body and said opening meet and when said rotating body is rotated from the initial position in one direction, a coin inserted from said coin slot is prevented from moving to the coin passage and is held in the coin containing section;
when said rotating body is rotated over 90 degrees from the initial position in one direction, the coin held in the coin containing section is discharged from said coin outlet via said opening; and
when said rotating body is rotated from the initial position in another direction, the coin held in the coin containing section moves to the coin passage, and is returned from said coin-return opening via the coin passage.

13. A coin identifying device comprising:
a body including a coin slot formed in an upper part, and a coin outlet and a coin-return opening formed in a lower part;
a rotating body rotatably provided inside said body;
an opening provided at a periphery of said rotating body;
a coin containing section which is provided in said rotating body, whereby the coin containing section is disposed adjacent to said opening at one end;
a coin passage formed in said rotating body, whereby the coin passage is disposed adjacent to one end of the coin containing section at one end, and is disposed adjacent to an exterior of said rotating body at another end;
a pair of coin stoppers which are provided in said rotating body, which close an opening between the coin containing section and the coin passage, which are movable between a closed position for preventing a coin from falling and an open position for allowing a coin to fall, and which are contacted by an elastic member; and
an engaging member which is provided in said body, whereby said engaging member does not engage with said pair of coin stoppers and prevents the coin in the coin containing section from falling to the coin passage at the time of rotation of said rotating body from the initial position in one direction, and engages with said pair of coin stoppers and moves said pair of coin stoppers to the open position to allow the coin in the coin containing section to fall to the coin passage and to be discharged from said coin-return opening at the time of rotation of said rotating body from the initial position in another direction;
wherein
when said rotating body is at the initial position where said coin slot of said body and said opening meet and when said rotating body is rotated from the initial position in one direction, a coin inserted from said coin slot is prevented from moving to the coin passage and is held in the coin containing section;
when said rotating body is rotated over 90 degrees from the initial position in one direction, the coin held in the coin containing section is discharged from said coin outlet via said opening; and
when said rotating body is rotated from the initial position in another direction, the coin held in the coin containing section moves to the coin passage, and is returned from said coin-return opening via the coin passage.

14. The coin identifying device according to claim 4, wherein
said rotating body has an engaging clutch convex portion, and said switching member has first and second engaging recesses; and
said switching member is movable between a position where said engaging clutch convex portion engages with said first engaging recess, and a position where said switching member is positioned by said engages clutch convex portion engaging with said second engaging recess.

15. The coin identifying device according to claim 4, wherein
said rotating body has an engaging recess, and said switching member has first and second engaging clutch convex portions; and
said switching member is movable between a position where said engaging recess engages with said first engaging clutch convex portion, and a position where said engaging recess engages with said second engaging clutch convex portion.

16. The coin identifying device according to claim 4, wherein
said switching member has an engaging clutch convex portion, and said rotating body has first and second engaging recesses; and
said switching member is movable between a position where said engaging clutch convex portion engages with said first engaging recess, and a position where said engaging clutch convex portion engages with said second engaging recess.

17. The coin identifying device according to claim 4, wherein
said switching member has an engaging recess, and said rotating body has first and second engaging clutch convex portions; and
said switching member is movable between a position where said engaging recess engages with said first engaging clutch convex portion, and a position where said engaging recess engages with said second engaging clutch convex portion, when said switching member is rotated in another direction against said rotating body.
